(19) United States
(12) Patent Application Publication
(10) Pub. No.: US 2011/0266984 A1
(43) Pub. Date: Nov. 3, 2011

(54) POWER DRIVE CONTROL DEVICE AND POWER DEVICE

(75) Inventors: Hisaaki WATANABE, Kanagawa (JP); Masahiro Asano, Kanagawa (JP)

(73) Assignee: Renesas Electronics Corporation

(21) Appl. No.: 13/087,107

(22) Filed: Apr. 14, 2011

(30) Foreign Application Priority Data
Apr. 28, 2010 (JP) 2010-102946

(51) Int. Cl. H02H 7/08

(52) U.S. Cl. 318/400.21

(57) ABSTRACT

A power drive control device is provided, in which, even if drive of a synchronous motor becomes impossible due to abnormalities of a control circuit for controlling the synchronous motor, it is possible to perform the drive control of the synchronous motor concerned easily with a simple configuration as emergency action. Failure of one of a first controller and a second controller is recovered by configuration of the other. Here, the first controller performs rotational drive control and regenerative control of a synchronous motor, based on a current signal of a fixed winding of the synchronous motor and a sense output from a rotation angle sensor of the synchronous motor, and the second controller performs power generation control of a synchronous generator based on a current signal of a fixed winding of the synchronous generator and a sense output from a rotation angle sensor of the synchronous generator. The drive control and the regenerative control (power generation control) which are performed by the first controller for controlling the synchronous motor and the second controller for controlling the synchronous generator are inextricably linked control.

### CROSS-REFERENCE TO RELATED APPLICATIONS

The disclosure of Japanese Patent Application No. 2010-102946 filed on Apr. 28, 2010 including the specification, drawings and abstract is incorporated herein by reference in its entirety.

### BACKGROUND

The present invention relates to technology of performing drive control of a synchronous motor and a synchronous generator, especially to technology recovering the failure of the pertaining control function, and relates to technology which is effective when applied to, for example, an electric vehicle and a hybrid vehicle.

Patent Document 1 discloses recovery technology to failure of a drive system in a hybrid vehicle which is provided with a transmission with a motor/generator and an engine driving shaft coupled with the transmission, the motor/generator being utilized for drive operation to obtain rotational driving force in response to a drive command and for regenerative operation to generate an electric power in response to a regeneration command. When output abnormality is detected in at least one of plural motor/generators and an engine, the present recovery technology aims at securing an output from a normal power source, according to the respective operation states.

An electric vehicle and a hybrid vehicle may be equipped with a synchronous generator which is exclusively used for power generation and not for drive operation, in addition to a motor/generator (synchronous motor) which is used for both regenerative operation and drive operation. Such a synchronous generator is employed in applications, such as storage of electric power by power generation at the time of engine-driven running, and storage of electric power by power generation which is performed concurrently with regenerative operation of the synchronous motor.
(Patent Document 1) Japanese Patent Laid-open No. 2005-291435

### SUMMARY

However, when failure has occurred in a drive system of an electric vehicle and a hybrid vehicle, there is no guarantee that a normal power source exists certainly. When failure occurs in a controller of a synchronous motor, it becomes impossible to drive the synchronous motor, even if the synchronous motor itself and power modules such as an inverter are normal. Same applies to a case where failure has occurred in an engine as well as a controller of a synchronous motor in a hybrid vehicle. Even if the technology disclosed by Patent Document 1 is applied under such a situation, it becomes impossible for the vehicle to run normally, even to move by itself as emergency action to a place where a maintenance service can be received, because the technology is based on the premise that a normal power source exists certainly. If a backup controller is prepared in advance to cope with such a situation, it will result in increase of a physical scale and cost because of a redundant configuration.

The purpose of the present invention is to provide a power drive control device and a power device to which the same is applied, in which it is possible to easily perform drive control of a synchronous motor with a simple configuration as emergency action, even when drive of the synchronous motor becomes impossible due to abnormalities of a control circuit which controls the synchronous motor.

Another purpose of the present invention is to provide a power drive control device and a power device to which the same is applied, in which it is possible to easily perform power generation control of a synchronous generator with a simple configuration as emergency action, even when power generation by the synchronous generator becomes impossible due to abnormalities of a control circuit which controls the synchronous generator.

The above and other purposes and new features will become clear from description of the specification and the accompanying drawings of the present invention.

The following explains briefly an outline of typical inventions to be disclosed by the present application.

That is, the present invention provides a first controller which performs rotational drive control and regenerative control of a synchronous motor, based on a current signal of a fixed winding of the synchronous motor and a sense output from a rotation angle sensor of the synchronous motor, and a second controller which performs power generation control of a synchronous generator based on a current signal of a fixed winding of the synchronous generator and a sense output from a rotation angle sensor of the synchronous generator. Failure of one of the first controller and the second controller is restored by the substitution of a configuration of the other. The drive control and the regenerative control (power generation control) which are performed by the first controller for controlling the synchronous motor and the second controller for controlling the synchronous generator are inextricably linked control. Therefore, substitution of all or a part of one controller by the other controller requires almost no addition of a new circuit configuration, and processing to be performed instead can be supported easily.

The following explains briefly an effect obtained by the typical inventions to be disclosed in the present application.

That is, even if drive of a synchronous motor becomes impossible due to abnormalities of a control circuit for controlling the synchronous motor, it is possible to perform the drive control of the synchronous motor concerned easily with a simple configuration as emergency action.

Even if power generation by a synchronous generator becomes impossible due to abnormalities of a control circuit for controlling the synchronous generator, it is possible to perform the power generation control of the synchronous generator concerned easily with a simple configuration as emergency action.

### BRIEF DESCRIPTION OF THE DRAWINGS

The present invention will become fully understood from the detailed description given hereinafter and the accompanying drawings, wherein:

FIG. 1 is a block diagram which illustrates a configuration of a power drive control device according to one embodiment of the present invention;

FIG. 2 is a block diagram illustrating a configuration in which an output of a microcomputer in failure is forcibly set into a high output-impedance state via an external terminal;

FIG. 3 is a block diagram illustrating a system configuration which employs a reset circuit provided with a function similar to a watchdog timer, as a configuration in which an output of a microcomputer in failure is forcibly set into a high output-impedance state;

FIG. 4 is a timing chart illustrating an operating sequence of drive control of a synchronous motor and power generation control of a synchronous generator;

FIG. 5 is a timing chart illustrating a control sequence in which, when a microcomputer for performing drive control of a synchronous motor has failure, all the motor control functions to be performed by the microcomputer are performed by another microcomputer instead;

FIG. 6 is a flow chart illustrating a flow of control when failure of a microcomputer for performing drive control of a synchronous motor is recovered using a marginal resource of the microcomputer concerned, assuming that an ADC responds to a conversion failure of current signals IV and IW (same for IU and IV or IU and IW);

FIG. 7 is a flow chart illustrating a flow of control when failure of a microcomputer for performing drive control of a synchronous motor is recovered using a marginal resource of the microcomputer concerned, assuming that an RDC responds to a resolver digital conversion failure of a resolver signal;

FIG. 8 is a flow chart illustrating a flow of control of another microcomputer employed for a substitution when a microcomputer for performing drive control of a synchronous motor has CPU failure and all of the motor drive control to be performed by the microcomputer concerned is performed by the another microcomputer employed for the substitution;

FIG. 9 is a flow chart illustrating a flow of control of another microcomputer employed for a substitution when a microcomputer for performing drive control of a synchronous motor has PWM failure and the motor drive control to be performed by the microcomputer concerned is performed by the another microcomputer employed for the substitution; and

FIG. 10 is a block diagram illustrating a configuration of a power drive control device in a case of controlling a synchronous motor and a synchronous generator by one microcomputer.

### DETAILED DESCRIPTION

### 1. Outline of Embodiment

First, an outline of a typical embodiment of the invention disclosed in the present application is explained. A numerical symbol of the drawing referred to in parentheses in the outline explanation about the typical embodiment only illustrates what is included in the concept of the component to which the numerical symbol is attached.

(1)<Recovering Failure of a Motor Drive Controller by a Generator Power Generation Controller>

A power drive control device (104, 204, 500) according to a typical embodiment of the present invention comprises a first controller (104) and a second controller (204). The first controller (104) is able to input a current signal (IV, IW) of a fixed winding of a synchronous motor (100) and a sense output (102) from a rotation angle sensor (101) of the synchronous motor, and able to perform drive control for rotating the synchronous motor and regenerative control for controlling power generation by the synchronous motor. The second controller (204) is able to input a current signal (IV, IW) of a fixed winding of a synchronous generator (200) and a sense output (202) from a rotation angle sensor (201) of the synchronous generator, and able to perform power generation control for controlling power generation by the synchronous generator. When it is detected that the first controller has unusable failure in the drive control of the synchronous motor, the second controller performs instead all or a part of the drive control to be performed by the first controller.

The drive control and the regenerative control (power generation control) which are performed by the first controller for controlling the synchronous motor and the second controller for controlling the synchronous generator are inextricably linked control, therefore, substitution of all or a part of one controller by the other controller requires almost no addition of a new circuit configuration, and processing to be performed instead can be supported easily.

(2)<All is Substituted for all or Partial Failure>

In the power drive control device of Paragraph (1), when unusable failure is detected in all or a part of the drive control of the synchronous motor performed by the first controller, the second controller performs instead all of the drive control of the synchronous motor to be performed by the first controller, by inputting a current signal of the fixed winding of the synchronous motor or a sense output from a rotation angle sensor of the synchronous motor, and performing the drive control for rotating the synchronous motor.

Since substitution can be performed en bloc, management of control processing to be performed instead is easy.

(3)<A Part is Substituted in a Failure Range>

In the power drive control device of Paragraph (1), when unusable failure is detected in a part of the drive control of the synchronous motor performed by the first controller, the second controller performs instead the control related to the unusable failure in the first controller.

Since substitution is performed only for a portion related to the failure, the amount of control processing to be performed instead can be lessened.

(4)<Dual Microcomputer System>

In the power drive control device of Paragraph (1), the first controller and the second controller are respectively a first microcomputer (104) and a second microcomputer (204), each provided with a different CPU.

Since what is necessary is just to control the operation of a peripheral circuit etc. according to an operation program of the CPU, the control processing to be performed instead can be specified easily.

(5)<Recognition Failure to a Current Signal of a Synchronous Motor>

In the power drive control device of Paragraph (4), when it is detected that the first microcomputer has unrecognizable failure (ADC failure) to a current signal of the fixed winding of the synchronous motor, the second microcomputer performs instead processing to recognize the current signal of the fixed winding of the synchronous motor among the drive control of the synchronous motor to be performed by the first microcomputer.

Since what is necessary is to take in a feedback signal according to an operation program of the CPU and just to carry out arithmetic processing, realization of the control processing to be performed instead is easy.

(6)<Detection of Recognition Failure to a Current Signal by a First Microcomputer>

In the power drive control device of Paragraph (5), the first microcomputer detects the unrecognizable failure to the current signal of the fixed winding of the synchronous motor, and notifies the detection result of the failure concerned to the second microcomputer.

For example, by utilizing a function which the first microcomputer has originally, such as processing to make a CPU determine whether a current signal of a fixed winding of a synchronous motor is as expected by a current command or a torque command as a drive command of a synchronous motor, the unrecognizable failure to the current signal of the fixed winding of the synchronous motor can be easily detected. When plural recognition functions of a current signal are provided, failure of a main recognition function can be detected by employing one of the recognition functions as an auxiliary recognition function with low sampling frequency. The second microcomputer which receives the detection result can avoid the burden of detecting the failure concerned.

(7)<Detection of Recognition Failure to a Current Signal by a Second Microcomputer>

In the power drive control device of Paragraph (5), the second microcomputer recognizes the current signal of the fixed winding of the synchronous motor, and returns the recognition result to the first microcomputer successively.

The present arrangement is effective when there is no current recognizing function to be employed as an auxiliary in the first microcomputer.

(8)<Recognition Failure of Rotation Angle>

In the power drive control device of Paragraph (4), when it is detected that the first microcomputer has unrecognizable failure to a sense output from the rotation angle sensor of the synchronous motor, in place of the first microcomputer performing the drive control of the synchronous motor, the second microcomputer performs the drive control of the synchronous motor by recognizing a current signal of the fixed winding of the synchronous motor and estimating a rotational position and speed of the synchronous motor.

Even if it is not possible to perform a highly precise rotation angle control based on a sense output from the rotation angle sensor of the synchronous motor, the drive control of the synchronous motor can be performed easily by a sensorless drive which is the existing control, with the second microcomputer using a current signal of the fixed winding of the synchronous motor. Even if the second microcomputer tries to utilize a sense output directly, cable run lengths of a communication channel of the sense output become too long, so that a circuit which converts the sense output into a rotation angle will be influenced markedly by parasitic capacitance at the input; accordingly, there is no effectiveness.

(9)<Detection of Recognition Failure of Rotation Angle by a First Microcomputer>

In the power drive control device of Paragraph (8), the first microcomputer detects the unrecognizable failure to the sense output from the rotation angle sensor of the synchronous motor, and notifies the detection result of the failure concerned to the second microcomputer.

For example, by using a function which is provided to the first microcomputer originally like a disconnection detection of a sense output path, it is possible to easily detect unrecognizable failure to a sense output from the rotation angle sensor. Accordingly, the second microcomputer which receives the detection result can avoid the burden of detecting the failure concerned.

(10)<CPU Failure>

In the power drive control device of Paragraph (4), when it is detected that the first microcomputer has failure of a CPU, in place of the first microcomputer performing the drive control of the synchronous motor, the second microcomputer performs the drive control of the synchronous motor by recognizing a current signal of the fixed winding of the synchronous motor and estimating the rotational position and speed of the synchronous motor.

Reliability deterioration due to the first microcomputer which has failure of a CPU can be recovered easily by the second microcomputer.

(11)<HiZ of Output at the Time of CPU Failure>

In the power drive control device of Paragraph (10), when the CPU of the second microcomputer detects a state of communication failure by performing a periodical communication with the CPU of the first microcomputer, the second microcomputer provides instructions to set an output of the first microcomputer to a high impedance state.

It is possible to prevent beforehand occurrence of the situation where the recovery processing using the second microcomputer is disturbed by undesirable output of the first microcomputer which has failure.

(12)<Holding of a Reset Instruction at the Time of CPU Failure>

The power drive control device of Paragraph (10) further comprises a reset circuit (401) which is able to initialize a timer count value, when a response from the first microcomputer is received before count-out of the timer count value, and which is able to provide a reset instruction to the first microcomputer concerned to hold the state, when a response from the first microcomputer is not received before the count-out.

The present arrangement can cope easily with cases where the first microcomputer is not provided with a function to set the output to a high impedance state in response to an instruction from the second microcomputer.

(13)<Configuration of a Microcomputer>

In the power drive control device of Paragraph (2), the first microcomputer comprises: a first A/D conversion circuit; a first angle conversion circuit; a first pulse generating circuit (115); and a first CPU. The first A/D conversion circuit is able to input a current signal of the fixed winding of the synchronous motor and able to convert the inputted current signal into a digital signal. The first angle conversion circuit is able to input a sense output from the rotation angle sensor of the synchronous motor and able to convert the inputted sense output into angle data. The first pulse generating circuit (115) is able to generate an inverter switch control signal for a inverter switch operation in response to a drive command of the synchronous motor, and able to generate a rectifier switch control signal for a rectifier switch operation in response to a regeneration command of the synchronous motor. The inverter switch control signal and the rectifier switch control signal are generated for a first switching circuit (103) which performs the inverter switch operation to generate a driving current to the fixed winding of the synchronous motor and the rectifier switch operation to rectify a regenerative current from the fixed winding of the synchronous motor. The first CPU is able to perform the drive control of the synchronous motor, by inputting outputs from the first A/D conversion circuit and the first angle conversion circuit, and by outputting the inverter switch control signal from the first pulse generating circuit to the first switching circuit in response to the drive command. The first CPU is also able to perform the regenerative control of the synchronous motor, by outputting the rectifier switch control signal from the first pulse generating circuit to the first switching circuit in response to the regeneration command. The second microcomputer comprises: a second A/D conversion circuit; a second angle conversion circuit; a second pulse generating circuit (215); and a second CPU. The second A/D conversion circuit is able to input a current signal of the synchronous generator and able to convert the inputted current signal into a digital signal. The second angle conversion circuit is able to input a sense output from the rotation angle sensor of the synchronous generator and able to convert the inputted sense output into angle data. The second pulse generating circuit (215) is able to generate a rectifier switch control signal for the rectifier switch operation in response to a power generation command of the synchronous generator. The rectifier switch control signal is generated for a second switching circuit (203) which performs a rectifier switch operation to rectify current from the fixed winding of the synchronous generator. The second CPU is able to perform the power generation control of the synchronous generator, by inputting outputs from the second A/D conversion circuit and the second angle conversion circuit, and by outputting the rectifier switch control signal from the second pulse generating circuit to the second switching circuit, in response to the power generation command. When failure is detected in the first A/D conversion circuit, the first pulse generating circuit, or the first CPU, in response to the drive command, the second A/D conversion circuit inputs a current signal of the fixed winding of the synchronous motor and converts the inputted current signal into a digital signal, the second CPU estimates the rotational position and speed of the synchronous motor based on the digital signal converted by the second A/D conversion circuit, and the drive control of the synchronous motor is performed, with the second pulse generating circuit letting the switching circuit perform the inverter switch operation.

Commonality of many peripheral circuits and processing is allowed in the first microcomputer and the second microcomputer; accordingly, the first microcomputer and the second microcomputer can be easily realized at low cost.

(14)<Single Microcomputer System>

In the power drive control device of Paragraph (4), the first controller and the second controller are one microcomputer (500) which shares a CPU and comprises a first peripheral circuit for the first controller and a second peripheral circuit for the second controller.

As is the case with Paragraph (4), since what is necessary is just to control the operation of a peripheral circuit etc. according to an operation program of the CPU, the control processing to be performed instead can be specified easily. The number of CPUs can be reduced.

(15)<Recognition Failure to a Current Signal of a Synchronous Motor>

In the power drive control device of Paragraph (14), when it is detected that the first peripheral circuit has unrecognizable failure to the feedback signal, the CPU performs recognition of a current signal of the fixed winding of the synchronous motor by using the second peripheral circuit instead, among the drive control of the synchronous motor to be performed by using the first peripheral circuit.

Since what is necessary is to take in a current signal of the fixed winding of the synchronous motor according to an operation program of the CPU and just to carry out arithmetic processing, realization of the control processing to be performed instead is easy.

(16)<Recognition Failure to a Rotation Angle>

In the power drive control device of Paragraph (14), when it is detected that the first peripheral circuit has unrecognizable failure to a sense output from the rotation angle sensor of the synchronous motor, the CPU performs the drive control of the synchronous motor, by recognizing a current signal of the fixed winding of the synchronous motor using the second peripheral circuit, and estimating the rotational position and speed of the synchronous motor, in stead of the drive control of the synchronous motor to be performed by using the first peripheral circuit.

Even if it is not possible to perform a highly precise rotation angle control based on a sense output from the rotation angle sensor of the synchronous motor, the drive control of the synchronous motor can be performed easily by a sensorless drive which is the existing control, with the second peripheral circuit using a current signal of the fixed winding of the synchronous motor. Even if the second peripheral circuit tries to utilize a sense output directly, cable run lengths of a communication channel of the sense output become too long, so that a circuit which converts the sense output into a rotation angle will be influenced markedly by parasitic capacitance at the input; accordingly, there is no effectiveness.

(17)<Configuration of a Microcomputer>

In the power drive control device of Paragraph (14), the first peripheral circuit comprises: a first A/D conversion circuit; a first angle conversion circuit; and a first pulse generating circuit. The first A/D conversion circuit is able to input a current signal of the fixed winding of the synchronous motor and able to convert the inputted current signal into a digital signal. The first angle conversion circuit is able to input a sense output from the rotation angle sensor of the synchronous motor and able to convert the inputted sense output into angle data. The first pulse generating circuit is able to generate an inverter switch control signal for the inverter switch operation in response to a drive command of the synchronous motor, and able to generate a rectifier switch control signal for the rectifier switch operation in response to a regeneration command of the synchronous motor. The inverter switch control signal and the rectifier switch control signal are generated for a first switching circuit which performs the inverter switch operation to generate a driving current to the fixed winding of the synchronous motor, and the rectifier switch operation to rectify a regenerative current from the fixed winding of the synchronous motor. The second peripheral circuit comprises: a second A/D conversion circuit; a second angle conversion circuit; and a second pulse generating circuit. The second A/D conversion circuit is able to input a current signal from the synchronous generator and able to convert the inputted current signal into a digital signal. The second angle conversion circuit is able to input a sense output from the rotation angle sensor of the synchronous generator and able to convert the inputted sense output into angle data. The second pulse generating circuit is able to generate a rectifier switch control signal for the rectifier switch operation in response to a power generation command of the synchronous generator. The rectifier switch control signal is generated for a second switching circuit which performs a rectifier switch operation to rectify current from the fixed winding of the synchronous generator. The CPU performs the drive control of the synchronous motor by inputting an output from the first A/D conversion circuit and the first angle conversion circuit, and outputting the inverter switch control signal from the first pulse generating circuit to the first switching circuit in response to the drive command. The CPU performs also the regenerative control of the synchronous motor by outputting the rectifier switch control signal from the first pulse generating circuit to the first switching circuit in response to the regeneration command. The CPU performs further the power generation control of the synchronous generator by inputting outputs from the second A/D conversion circuit and the second angle conversion circuit, and by outputting the rectifier switch control signal from the second pulse generating circuit to the second switching circuit in response to the power generation command. When failure is detected in the first A/D conversion circuit or the first pulse generating circuit, the second A/D conversion circuit inputs a current signal of the fixed winding of the synchronous motor and converts the inputted current signal into a digital signal, in response to the drive command, and the CPU performs the drive control of the synchronous motor with the second pulse generating circuit letting the switching circuit perform the inverter switch operation, by estimating the rotational position and speed of the synchronous motor based on the digital signal converted by the second A/D conversion circuit.

Commonality of many peripheral circuits and processing is allowed in the first peripheral circuit and the second peripheral circuit; accordingly, the first peripheral circuit and the second peripheral circuit can be easily realized at low cost.

(18)<Self Recovery of Failure in a Motor Drive Controller>

A power drive control device according to another embodiment of the present invention comprises: a first controller; and a second controller. The first controller is able to input a current signal of a fixed winding of a synchronous motor and a sense output from a rotation angle sensor of the synchronous motor, and able to perform drive control for rotating the synchronous motor and regenerative control for controlling power generation by the synchronous motor. The second controller is able to input a current signal of a fixed winding of a synchronous generator and a sense output from a rotation angle sensor of the synchronous generator, and able to perform power generation control for controlling power generation by the synchronous generator. The first controller and the second controller are respectively a first microcomputer and a second microcomputer, each provided with a different CPU. The first microcomputer comprises multiplexed A/D conversion circuits which convert a current signal of the fixed winding of the synchronous motor into a digital signal. When a main A/D conversion circuit is in failure, an auxiliary A/D conversion circuit is switched so as to act as a substitute and converts a current signal of the fixed winding of the synchronous motor into a digital signal. The first microcomputer comprises an angle conversion circuit which inputs a sense output from the rotation angle sensor of the synchronous motor and converts the sense output into angle data. When the angle conversion circuit is in failure, the first microcomputer performs the drive control of the synchronous motor, by estimating the rotational position and speed of the synchronous motor based on the digital signal into which the A/D conversion circuit has converted the current signal of the fixed winding of the synchronous motor.

It is possible to recover from specific failure, such as failure of an A/D conversion circuit or failure of an angle conversion circuit, by using the own first microcomputer. The recovery requires almost no addition of a new circuit configuration, and processing to be performed instead can be supported easily.

(19)<Recovering Failure of a Motor Drive Controller by a Generator Power Generation Controller>

A power device according to another embodiment of the present invention comprises: a synchronous motor; a first switching circuit; a rotation angle sensor of the synchronous motor; a first controller; a synchronous generator; a second switching circuit; a rotation angle sensor of the synchronous generator; and a second controller. The first switching circuit is able to perform an inverter switch operation to generate a driving current to a fixed winding of the synchronous motor, and able to perform a rectifier switch operation to rectify a regenerative current from the fixed winding of the synchronous motor. The first controller is able to input a current signal of the fixed winding of the synchronous motor and a sense output from the rotation angle sensor of the synchronous motor. The first controller is also able to output an inverter switch control signal for the inverter switch operation to the first switching circuit in response to a drive command of the synchronous motor, and able to output a rectifier switch control signal for the rectifier switch operation to the first switching circuit in response to a regeneration command of the synchronous motor. The second switching circuit is able to perform a rectifier switch operation to rectify current from a fixed winding of the synchronous generator. The second controller is able to input a sense signal of the rotation angle sensor of the synchronous generator and a current signal from the fixed winding of the synchronous generator, and able to output a rectifier switch control signal for the rectifier switch operation to the second switching circuit in response to a power generation command of the synchronous generator. When it is detected that the first controller has unusable failure in the drive control of the synchronous motor, the second controller performs instead all or a part of the drive control to be performed by the first controller.

The drive control and the regenerative control (power generation control) which are performed by the first controller for controlling the synchronous motor and the second controller for controlling the synchronous generator are inextricably linked control. Therefore, substitution of all or a part of one controller by the other controller requires almost no addition of a new circuit configuration, and processing to be performed instead can be supported easily.

(20)<Dual Microcomputer System>

In the power device of Paragraph (19), the first controller and the second controller are respectively a first microcomputer and a second microcomputer, each provided with a different CPU.

Since what is necessary is just to control the operation of a peripheral circuit etc. according to an operation program of the CPU, the control processing to be performed instead can be specified easily.

(21)<Recognition Failure to a Current Signal of a Synchronous Motor>

In the power device of Paragraph (20), when it is detected that the first microcomputer has unrecognizable failure to a current signal of the fixed winding of the synchronous motor, the second microcomputer performs instead processing to recognize the current signal of the fixed winding of the synchronous motor among the drive control of the synchronous motor to be performed by the first microcomputer.

Since what is necessary is to take in a current signal of the synchronous motor according to an operation program of the CPU and just to carry out arithmetic processing, realization of the control processing to be performed instead is easy.

(22)<Recognition Failure to a Rotation Angle>

In the power device of Paragraph (20), when it is detected that the first microcomputer has unrecognizable failure to a sense output from the rotation angle sensor of the synchronous motor, in place of the first microcomputer performing the drive control of the synchronous motor, the second microcomputer performs the drive control of the synchronous motor by recognizing a current signal of the fixed winding of the synchronous motor and estimating the rotational position and speed of the synchronous motor.

Even if it is not possible to perform a highly precise rotation angle control based on a sense output from the rotation angle sensor of the synchronous motor, the drive control of the synchronous motor can be performed easily by a sensorless drive which is the existing control, with the second microcomputer using a current signal of the fixed winding of the synchronous motor. Even if the second microcomputer tries to utilize a sense output directly, cable run lengths of a communication channel of the sense output become too long, so that a circuit which converts the sense output into a rotation angle will be influenced markedly by parasitic capacitance at the input; accordingly, there is no effectiveness.

(23)<CPU Failure>

In the power device of Paragraph (20), when it is detected that the first microcomputer has failure of a CPU, in place of the first microcomputer performing the drive control of the synchronous motor, the second microcomputer performs the drive control of the synchronous motor by recognizing a current signal of the fixed winding of the synchronous motor and estimating the rotational position and speed of the synchronous motor.

Reliability deterioration due to the first microcomputer which has failure of a CPU can be recovered easily by the second microcomputer.

(24)<Single Microcomputer System>

In the power device of Paragraph (19), the first controller and the second controller are one microcomputer which shares a CPU and comprises a first peripheral circuit for the first controller and a second peripheral circuit for the second controller.

As is the case with Paragraph (20), since what is necessary is just to control the operation of a peripheral circuit etc., according to an operation program of the CPU, the control processing to be performed instead can be specified easily. The number of CPUs can be reduced.

(25)<Self Recovery of Failure in a Motor Drive Controller>

A power device according to another embodiment of the present invention comprises: a synchronous motor; a first switching circuit; a rotation angle sensor of the synchronous motor; a first controller; a synchronous generator; a second switching circuit; a rotation angle sensor of the synchronous generator; and a second controller. The first switching circuit is able to perform an inverter switch operation to generate a driving current to a fixed winding of the synchronous motor, and able to perform a rectifier switch operation to rectify a regenerative current from the fixed winding of the synchronous motor. The first controller is able to input a current signal of the fixed winding of the synchronous motor and a sense output from the rotation angle sensor of the synchronous motor. The first controller is also able to output an inverter switch control signal for the inverter switch operation to the first switching circuit in response to a drive command, and able to output a rectifier switch control signal for the rectifier switch operation to the first switching circuit in response to a regeneration command. The second switching circuit is able to perform a rectifier switch operation to rectify current from a fixed winding of the synchronous generator. The second controller is able to input a sense signal of the rotation angle sensor of the synchronous generator and a current signal from the fixed winding of the synchronous generator, and is able to output a rectifier switch control signal for the rectifier switch operation to the second switching circuit in response to a power generation command. The first controller and the second controller are respectively a first microcomputer and a second microcomputer, each provided with a different CPU. The first microcomputer comprises multiplexed A/D conversion circuits which convert a current signal of the fixed winding of the synchronous motor into a digital signal, and, when a main A/D conversion circuit is in failure, an auxiliary A/D conversion circuit is switched so as to act as a substitute and converts a current signal of the fixed winding of the synchronous motor into a digital signal. The first microcomputer comprises an angle conversion circuit which inputs a sense output from the rotation angle sensor of the synchronous motor and converts the sense output into angle data, and, when the angle conversion circuit is in failure, the first microcomputer performs drive control of the synchronous motor, by estimating the rotational position and speed of the synchronous motor based on the digital signal into which the A/D conversion circuit has converted the current signal of the fixed winding of the synchronous motor.

It is possible to recover from specific failure, such as failure of an A/D conversion circuit or failure of an angle conversion circuit, by using the own first controller. The recovery requires almost no addition of a new circuit configuration, and processing to be performed instead can be supported easily.

(26)<Recovering Failure of a Generator Power Generation Controller by a Motor Drive Controller>

A power device according to another embodiment of the present invention comprises a first controller and a second controller. The first controller is able to input a current signal of a fixed winding of a synchronous motor and a sense output from a rotation angle sensor of the synchronous motor, and is able to perform drive control for rotating the synchronous motor and regenerative control for controlling power generation by the synchronous motor. The second controller is able to input a current signal of a fixed winding of a synchronous generator and a sense output from a rotation angle sensor of the synchronous generator, and able to perform power generation control for controlling power generation by the synchronous generator. When it is detected that the second controller has unusable failure in the power generation control of the synchronous generator, the first controller performs instead all or a part of the power generation control of the synchronous generator to be performed by the second controller.

The drive control and the regenerative control (power generation control) which are performed by the first controller for controlling the synchronous motor and the second controller for controlling the synchronous generator are inextricably linked control. Therefore, substitution of all or a part of one controller by the other controller requires almost no addition of a new circuit configuration, and processing to be performed instead can be supported easily.

(27)<Self Recovery of Failure in a Generator Power Generation Controller>

A power device according to another embodiment of the present invention comprises a first controller and a second controller. The first controller is able to input a current signal of a fixed winding of a synchronous motor and a sense output from a rotation angle sensor of the synchronous motor, and able to perform drive control for rotating the synchronous motor and regenerative control for controlling power generation by the synchronous motor. The second controller is able to input a current signal of a fixed winding of a synchronous generator and a sense output from a rotation angle sensor of the synchronous generator, and able to perform power generation control for controlling power generation by the synchronous generator. The first controller and the second controller are respectively a first microcomputer and a second microcomputer, each provided with a different CPU. The second microcomputer comprises multiplexed A/D conversion circuits which convert the current signal into a digital signal, and, when a main A/D conversion circuit is in failure, an auxiliary A/D conversion circuit is switched so as to act as a substitute and converts the current signal into a digital signal. The second microcomputer comprises an angle conversion circuit which inputs a sense output from the rotation angle sensor of the synchronous generator and converts the sense output into angle data, and, when the angle conversion circuit is in failure, the second microcomputer performs the power generation control of the synchronous generator, by estimating a rotational position and speed of the synchronous generator based on the digital signal into which the A/D conversion circuit has converted the current signal.

It is possible to recover from specific failure, such as failure of an A/D conversion circuit or failure of an angle conversion circuit, by using the own second microcomputer. The recovery requires almost no addition of a new circuit configuration, and processing to be performed instead can be supported easily.

(28)<Recovering Failure of a Generator Power Generation Controller by a Motor Drive Controller>

A power device according to another embodiment of the present invention comprises: a synchronous motor; a first switching circuit; a rotation angle sensor of the synchronous motor; a first controller; a synchronous generator; a second switching circuit; a rotation angle sensor of the synchronous generator; and a second controller. The first switching circuit is able to perform an inverter switch operation to generate a driving current to a fixed winding of the synchronous motor, and able to perform a rectifier switch operation to rectify a regenerative current from the fixed winding of the synchronous motor. The first controller is able to input a current signal of the fixed winding of the synchronous motor and a sense output from the rotation angle sensor of the synchronous motor. The first controller is also able to output an inverter switch control signal for the inverter switch operation to the first switching circuit in response to a drive command, and able to output a rectifier switch control signal for the rectifier switch operation to the first switching circuit in response to a regeneration command. The second switching circuit is able to perform a rectifier switch operation to rectify current from a fixed winding of the synchronous generator. The second controller is able to input a sense signal of the rotation angle sensor of the synchronous generator and a current signal from the fixed winding of the synchronous generator, and able to output a rectifier switch control signal for the rectifier switch operation to the second switching circuit in response to a power generation command. When it is detected that the second controller has unusable failure in the power generation control of the synchronous generator, the first controller performs instead all or a part of the power generation control to be performed by the second controller.

The drive control and the regenerative control (power generation control) which are performed by the first controller for controlling the synchronous motor and the second controller for controlling the synchronous generator are inextricably linked control. Therefore, substitution of all or a part of one controller by the other controller requires almost no addition of a new circuit configuration, and processing to be performed instead can be supported easily.

(29)<Self Recovery of Failure in a Generator Power Generation Controller>

A power device according to another embodiment of the present invention comprises: a synchronous motor; a first switching circuit; a rotation angle sensor of the synchronous motor; a first controller; a synchronous generator; a rotation angle sensor of the synchronous generator; and a second controller. The first switching circuit is able to perform an inverter switch operation to generate a driving current to a fixed winding of the synchronous motor, and able to perform a rectifier switch operation to rectify a regenerative current from the fixed winding of the synchronous motor. The first controller is able to input a current signal of the fixed winding of the synchronous motor and a sense output from the rotation angle sensor of the synchronous motor. The first controller is also able to output an inverter switch control signal for the inverter switch operation to the first switching circuit in response to a drive command, and able to output a rectifier switch control signal for the rectifier switch operation to the first switching circuit in response to a regeneration command. The second controller is able to input a sense signal of the rotation angle sensor of the synchronous generator and a current signal from the fixed winding of the synchronous generator, and is able to output a rectifier switch control signal for the rectifier switch operation to the second switching circuit in response to a power generation command. The first controller and the second controller are respectively a first microcomputer and a second microcomputer, each provided with a different CPU. The second microcomputer comprises multiplexed A/D conversion circuits which convert a current signal of a fixed winding of the synchronous generator into a digital signal, and, when a main A/D conversion circuit is in failure, an auxiliary A/D conversion circuit is switched so as to act as a substitute and converts a current signal of the fixed winding of the synchronous generator into a digital signal. The second microcomputer comprises an angle conversion circuit which inputs a sense output from the rotation angle sensor of the synchronous generator and converts the sense output into angle data, and, when the angle conversion circuit is in failure, the second microcomputer performs the power generation control of the synchronous generator, by estimating the rotational position and speed of the synchronous generator based on the digital signal into which the A/D conversion circuit has converted the current signal of the fixed winding of the synchronous generator.

It is possible to recover from specific failure, such as failure of an A/D conversion circuit or failure of an angle conversion circuit, by using the own second microcomputer. The recovery requires almost no addition of a new circuit configuration, and processing to be performed instead can be supported easily.

### 2. Details of Embodiment

The embodiments are explained in more detail.

### Embodiment 1

### A System Configuration of a Power Drive Control Device

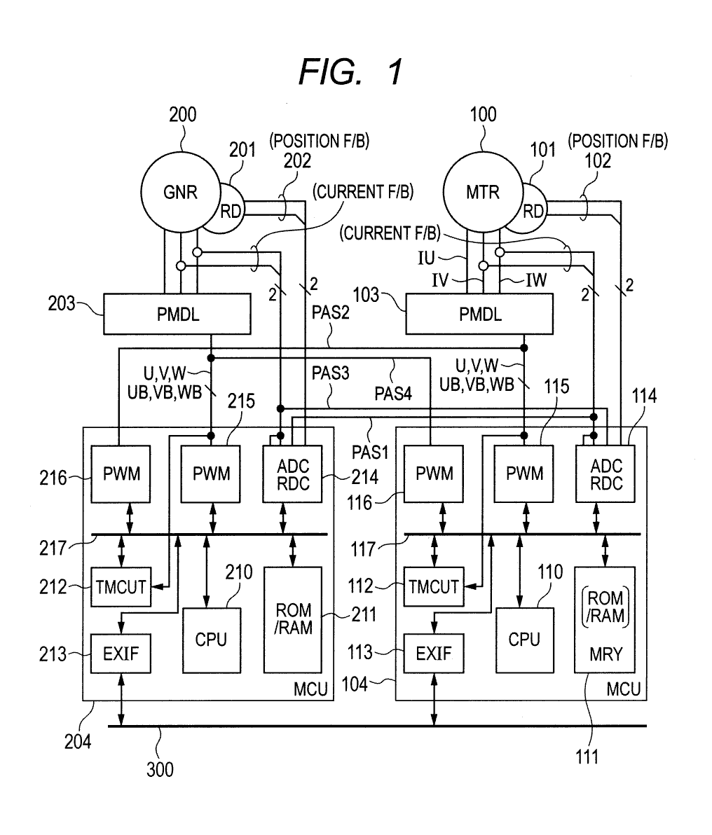

FIG. 1 illustrates a configuration of a power drive control device according to one embodiment of the present invention. The power drive control device illustrated in FIG. 1 is a device which is mounted, although not limited in particular, in an electric vehicle or a hybrid vehicle, and which controls a synchronous motor functioning as a motor/generator used for both drive operation/regenerative operation, and a synchronous generator exclusively used for power generation but not for drive operation. The power drive control device is configured by some semiconductor devices, such as a microcomputer and others which are mounted on a circuit board.

In FIG. 1, a synchronous motor (MTR) 100 is a motor called an IPM (Internal Permanent Magnet) motor of a three-phase alternating current type, which uses a permanent magnet for generating a rotating magnetic field and has a three-phase coil of a U-phase winding, a V-phase winding, and a W-phase winding, for generating a fixed magnetic field. In FIG. 1, IU, IV, and IW mean a current signal of the U-phase winding, a current signal of the V-phase winding, and a current signal of the W-phase winding, respectively. A rotation angle sensor 101 detects a rotation angle of a motor shaft of the synchronous motor, and is composed, although not limited in particular, of a variable reluctance (VR) type resolver (RD) which detects a rotation angle using an alternating current magnetic field. The rotation angle sensor 101 outputs a signal modulated by a sine wave and a signal modulated by a cosine wave of the rotation angle of a rotor, as a resolver output signal (sense output) 102. A power module (PMDL) 103 is configured with a switching circuit. When rotating the synchronous motor 100, the power module 103 functions as an inverter which converts a direct current signal supplied from a battery (not shown) into three-phase alternating current signals IU, IV, and IW, and outputs them to the synchronous motor 100. When slowing down the synchronous motor 100, the power module 103 functions as a rectifier which converts three-phase alternating current signals IU, IV, and IW, generated by the synchronous motor 100 into a direct current signal and supplies it to the battery. In the switch control for the inverter operation and the switch control for the rectifying operation of the power module 103, although not limited in particular, the switching control signals U, V, and W and the inverted switching control signals UB, VB, and WB are used.

A microcomputer 104 performs drive control to rotate the synchronous motor 100 by inputting the current signals IV and IW of the synchronous motor 100 and the resolver output signal 102 from the rotation angle sensor 101, and regenerative control to control the power generation by the synchronous motor 100. Furthermore, the microcomputer 104 performs a recovery control etc. when failure occurs in a power generation control function by a microcomputer on the side of the synchronous generator. Although not limited in particular, the microcomputer 104 is formed by manufacturing technology of a complementary MOS IC on a semiconductor substrate like a single crystal silicon.

The microcomputer 104 includes a central processing unit (CPU) 110 which executes a program; a memory (MRY) 111 which comprises a ROM storing the program executed by the CPU 110 and a RAM used for a work space of the CPU 110 and others; a timer counter (TMCUT) 112; a communication interface circuit (EXIF) 113 which communicates with the exterior; and in particular, a conversion circuit (ADC, RDC) 114 and a switching control circuits (PWM) 115 and 116, which are used for control of the synchronous motor 100. These components are coupled with each other by means of an interface of an internal bus 117 for example.

The conversion circuit 114 includes an A/D conversion circuit (ADC) which converts current signals IV and IW, etc. into a digital signal, and a resolver digital converter (RDC) which converts a resolver output signal 102 into digital angle data. As is the case with most microcomputers, plural A/D conversion circuits are provided here so that A/D conversion of plural signals may be dealt with. The resolver digital converter (RDC) may be an external part, or may be substituted by one of the A/D conversion circuits (ADC), depending on a configuration.

The switching control circuits 115 and 116 are configured with a pulse width modulation circuit (PWM) for example, and have a function to output plural pulse signals with a required phase and frequency, under the control of the CPU 110. The PWM 115 is utilized for generation of switching control signals U, V, and W and the respectively inverted switching control signals UB, VB, and WB. The signal wave form and output timing of the switching control signals are controlled by the CPU 110 optimally, corresponding to the time of the drive control and to the time of the regenerative control.

In FIG. 1, a synchronous generator (GNR) 200 is a generator of a three-phase alternating current generation type which uses a permanent magnet for generating a rotating magnetic field, and has a three-phase coil of a U-phase winding, a V-phase winding, and a W-phase winding, for generating a fixed magnetic field. Fundamental structure of the synchronous generator 200 is the same as that of the synchronous motor 100. In FIG. 1, IU, IV, and IW mean a current signal of the U-phase winding, a current signal of the V-phase winding, and a current signal of the W-phase winding, respectively. A rotation angle sensor 201 detects a rotation angle of a rotor shaft of the synchronous generator, and is composed, although not limited in particular, of a variable reluctance (VR) type resolver (RD) which detects a rotation angle using an alternating current magnetic field. The rotation angle sensor 201 outputs a signal modulated by a sine wave and a signal modulated by a cosine wave of the rotation angle of a rotor, as a resolver output signal (sense output) 202. A power module (PMDL) 203 is configured with a switching circuit functioning as a rectifier which converts three-phase alternating current signals IU, IV, and IW into a direct current signal and supplies it to a battery (not shown), when generating electricity using the synchronous generator 200. In the switch control for the rectifying operation of the power module 203, although not limited in particular, the switching control signals U, V, and W and the inverted switching control signals UB, VB, and WB are used.

A microcomputer 204 performs power generation control to control power generation by the synchronous generator 200, by inputting the current signals IV and IW of the synchronous generator 200 and the resolver output signal 202 from the rotation angle sensor 201, and performs recovery control when failure occurs in the control function of the synchronous motor 100 to be performed by the microcomputer 104. Although not limited in particular, the microcomputer 204 is formed by manufacturing technology of a complementary MOS IC on a semiconductor substrate like a single crystal silicon.

The microcomputer 204 includes a central processing unit (CPU) 210 which executes a program; a memory (MRY) 211 which comprises a ROM storing the program executed by the CPU 210 and a RAM used for a work space of the CPU 210 and others; a timer counter (TMCUT) 212; a communication interface circuit (EXIF) 213 which communicates with the exterior; and in particular, a conversion circuit (ADC, RDC) 214 and a switching control circuits (PWM) 215 and 216, which are used for control of the synchronous generator 200. These components are coupled with each other by means of an interface of an internal bus 217 for example.

The conversion circuit 214 includes an A/D conversion circuit (ADC) which converts current signals IV and IW, etc. into a digital signal, and a resolver digital converter (RDC) which converts a resolver output signal 202 into digital angle data. As is the case with most microcomputers, plural A/D conversion circuits are provided here so that A/D conversion of plural signals may be dealt with. The resolver digital converter (RDC) may be an external part, or may be substituted by one of the A/D conversion circuits (ADC), depending on a configuration.

The switching control circuits 215 and 216 are configured with a pulse width modulation circuit (PWM) for example, and have a function to output plural pulse signals with a required phase and frequency, under the control of the CPU 210. The PWM 215 is utilized for generation of switching control signals U, V, and W and the respectively inverted switching control signals UB, VB, and WB. The signal wave form and output timing of the switching control signals are controlled by the CPU 210 optimally, corresponding to the time of the power generation control and to the time of the recovery control.

The microcomputers 104 and 204 exchange necessary information by communicating via an external communication path 300 composed of a vehicle-installed LAN, such as a CAN (Controller Area Network).

<<Drive Control and Regenerative Control of a Synchronous Motor>>

When a drive command of the synchronous motor is supplied to the CPU 110 from the exterior corresponding to accelerator operation of a vehicle, etc., the CPU 110 generates a torque command or a current command according to instructions of the command. When the drive command is supplied, a current direction of the power module 103 is controlled to the direction from the battery to the synchronous motor 100. The CPU 110 recognizes a rotation angle of the synchronous motor 100 in terms of the digital angle data from the resolver digital converter (RDC) which receives the resolver output signal 102, and also recognizes an output current value to the current command (or torque command) in terms of feedback of the current signals IV and IW through the A/D conversion circuit (ADC). Based on the recognition results, the CPU 110 controls the PWM 115 to output the switching control signals U, V, and W and the inverted switching control signals UB, VB, and WB with a required phase and frequency. Three-phase alternating current signals IU, IV, and IW are supplied to the synchronous motor 110 by the inverter operation of the power module 103, and the drive control of the synchronous motor 110 is performed.

When a regeneration command of the synchronous motor is supplied to the CPU 110 from the exterior corresponding to brake operation of a vehicle, etc., the CPU 110 generates a regenerative torque command or a regenerative current command according to instructions of the command. When the regeneration command is supplied, a current direction of the power module 103 is controlled to the direction from the synchronous motor 100 to the battery. The CPU 110 recognizes a rotation angle of the synchronous motor 100 on the way of damping, in terms of the digital angle data from the resolver digital converter (RDC) of the conversion circuit 114 which receives the resolver output signal 102, and also recognizes a regenerative current value to the regenerative current command (or the regenerative torque command), in terms of feedback of the regenerative current signals IV and IW through the A/D conversion circuit (ADC) of the conversion circuit 114. Based on the recognition results, the CPU 110 controls the PWM 115 to output the switching control signals U, V, and W and the inverted switching control signals UB, VB, and WB with a required phase and frequency. By rectifying operation of the power module 103, three-phase alternating current signals IU, IV, and IW are converted into a direct current signal, and supplied to the battery.

<<Power Generation Control of a Synchronous Generator>>

When a power generation command of the synchronous generator is supplied to the CPU 210 from the exterior, the CPU 210 generates a power generation torque command or a power generation current command according to instructions of the command. When the power generation command is supplied, a current direction of the power module 203 is controlled to the direction from the synchronous generator 200 to the battery. The CPU 210 recognizes a rotation angle of the synchronous generator 200, in terms of the digital angle data from the resolver digital converter (RDC) of the conversion circuit 214 which receives the resolver output signal 202, and also recognizes a power generation current value to the power generation current command (or the power generation torque command), in terms of feedback of the power generation current signals IV and IW through the A/D conversion circuit (ADC) of the conversion circuit 214. Based on the recognition results, the CPU 210 controls the PWM 215 to output the switching control signals U, V, and W and the inverted switching control signals UB, VB, and WB with a required phase and frequency. By rectifying operation of the power module 203, three-phase alternating current signals IU, IV, and IW are converted into a direct current signal, and supplied to the battery.

<<Mode of Recovery Control>>

The recovery control mode to failure of a control function in the power drive control device illustrated in FIG. 1 is as follows.

Failure as a recovery target in the drive control function to the synchronous motor 100 includes conversion failure of the current signals IV and IW by the ADC of the conversion circuit 114, conversion failure of the resolver output signal 102 by the RDC of the conversion circuit 114 to digital angle data, failure of the PWM 115, and failure of the CPU 110. Recovery methods are substitution of a failure range by the microcomputer 204, substitution of all by the microcomputer 204, and substitution by a reserve resource of the microcomputer 104 itself. When such failure occurs, an electric vehicle can not run anymore, and a hybrid vehicle also can not run if engine-driven running is impracticable. In order to avoid such situation, the recovery processing according to the present invention can attain the purpose if the motor drive control is not smooth enough but can drive the motor barely, giving assurance to move by oneself as emergency action to a place where a maintenance service can be received.

Failure as a recovery target in the power generation control function to the synchronous generator 200 includes conversion failure of the current signals IV and IW by the ADC of the conversion circuit 214, conversion failure of the resolver output signal 202 by the RDC of the conversion circuit 214 to digital angle data, failure of the PWM 216, and failure of the CPU 210. Recovery methods are substitution of a failure range by the microcomputer 104, substitution of all by the microcomputer 104, and substitution by a reserve resource of the microcomputer 204 itself. When such failure occurs, it becomes incapable to charge a battery under the situation where battery charging is urgent necessity for driving. Accordingly, the recovery processing according to the present invention can attain the purpose if the power generation control to the synchronous generator is not smooth enough but can carry out the battery charging barely.

When plural kinds of substitution processing are available to the same failure, which is to be selected may be determined in advance by an operation program of the CPU. Accordingly, it is necessary to decide in advance redundant connecting relationship for the substitution between the control side of the synchronous motor 100 and the control side of the synchronous generator 200. Hereinafter, the contents of control in the recovery control are explained one by one. In the following, items 1 to 4 describe cases where failure occurs on the side of the microcomputer 104, and items 5 to 8 describe cases where failure occurs on the side of the microcomputer 204.

<<1. Recovering Conversion Failure of Current Signals IV and IW in the Drive Control, within a Failure Range>>

When there occurs failure that the ADC of the conversion circuit 114 can not perform the conversion of the current signals IV and IW which are fed back from the synchronous motor 100, the conversion operation of the ADC in the conversion circuit 114 of the microcomputer 104 is substituted by the conversion operation of the ADC in the conversion circuit 214 of the microcomputer 204. That is, the conversion circuit 214 of the microcomputer 204 receives the current signals IV and IW from a path PAS1, the CPU 210 transmits digital data converted by the ADC to the microcomputer 104 from the external communication interface circuit 213, and the CPU 110 of the microcomputer 104 receives the digital data, and uses it for the drive control of the motor. Since the microcomputer 204 should just take in the current signals IV and IW according to the operation program of the CPU 210 and just carry out arithmetic processing, realization of the control processing to be performed instead is easy.

When the microcomputer 104 itself performs failure detection of the ADC of the conversion circuit 114, failure is detected by inquiring into the state where a detection value deviates from a target value greatly in the feedback control performed by the CPU 110 using the current signals IV and IW, or, failure of the main ADC is detected by employing one of the plural ADCs as an auxiliary ADC with low sampling frequency. The microcomputer 104 must notify the microcomputer 204 of the detection result of the failure occurrence concerned. In this way, the unrecognizable failure to the current signals IV and IW of the fixed winding of the synchronous motor 100 can be easily detected, by utilizing a function which the microcomputer 104 has originally, like processing to make the CPU 110 determine whether the current signals IV and IW of the fixed winding of the synchronous motor 100 are as expected by the current command or the torque command as the drive command of the synchronous motor 100. The microcomputer 204 which receives the detection result can avoid the burden of detecting the failure concerned.

When the microcomputer 204 is used for failure detection of the ADC of the conversion circuit 114, one of the plural ADCs of the microcomputer 204 is employed as an auxiliary ADC with low sampling frequency, and the conversion result is periodically notified to the microcomputer 104. The present scheme is effective when there is no available ADC to be used as an auxiliary ADC in the microcomputer 104.

When there occurs failure that the ADC of the conversion circuit 114 can not perform the conversion of the current signals IV and IW which are fed back from the synchronous motor 100, if the conversion circuit 114 has plural ADCs, the recovery may be performed by switching to conversion by another ADC. Also in this case, the failure may be detected by the same way as described above.

<<2. Recovering Conversion Failure to a Resolver Digital Angle Data in the Drive Control, within a Failure Range>>

When it is detected that failure in conversion exists in the RDC of the conversion circuit 114 to the resolver output signal 102 from the rotation angle sensor 101 of the synchronous motor 100, as substitute for the conversion by the RDC of the conversion circuit 114 of the microcomputer 104, a free ADC in the conversion circuit 114 inputs the current signals IV and IW of the synchronous motor 100 and converts them into digital data, and the CPU 110 estimates a rotational position of the motor based on the digital data. Accordingly, the drive control of the synchronous motor is performed. Even if it is not possible to perform a highly precise rotation angle control based on the resolver output signal 102 from the rotation angle sensor 101 of the synchronous motor 100, the drive control of the synchronous motor can be performed easily by a sensorless drive which is the existing control, by using the current signals IV and IW.

When there is no free ADC in the conversion circuit 114, the ADC of the conversion circuit 214 of the second microcomputer 204 inputs the current signals IV and IW of the synchronous motor 100 from the path PAST, and converts them into digital data, the microcomputer 104 receives the conversion result via a communication path 300, and the CPU 110 estimates the rotational position of the motor based on the digital data. Accordingly, the drive control of the synchronous motor may be performed. At this time, it is not a best policy to convert the resolver output signal 102 of the synchronous motor 100 using the RDC of the conversion circuit 214 of the microcomputer 204. Namely, even if the second microcomputer 204 tries to utilize the resolver output signal 102 directly, cable run lengths of a communication channel of the resolver output signal 102 become too long, so that the RDC which converts the resolver output signal 102 into a rotation angle will be influenced markedly by parasitic capacitance at the input, and it is likely that the conversion accuracy falls significantly. Therefore, there is no effectiveness.

Failure in conversion of the RDC of the conversion circuit 114 may be detected by analyzing the conversion result by the ADC of the conversion circuit 114 with the CPU 110, or by using simultaneously the disconnection detection function of the RDC in the conversion circuit 114, furthermore by inquiring into the state where a detection value deviates from a target value greatly in the feedback control performed by the CPU 110 using the output of the RDC, and others.

<<3. Recovering Failure of the Microcomputer 104 Other Than the CPU 110, by the Entire of the Microcomputer 204>>

In any one of failure of the PWM 115 assigned to control of the PMDL 103, conversion failure of the current signals IV and IW, and conversion failure to the resolver digital angle data, the drive control of the synchronous motor to be performed by the microcomputer 104 may be recovered by the entire of the microcomputer 204.

For example, when it is detected that failure in conversion exists in the RDC of the conversion circuit 114 to the resolver output signal 102 from the rotation angle sensor 101 of the synchronous motor 100, as substitute for the conversion by the RDC of the conversion circuit 114 of the microcomputer 104, the ADC of the conversion circuit 214 of the microcomputer 204 inputs the current signals IV and IW of the synchronous motor 100 from the path PAST, and converts them into digital data, and the CPU 210 estimates the rotational position and speed of the motor 100 based on the conversion result. Accordingly, the drive control of the synchronous motor 100 is performed through the path PAS2 using the PWM 216. In this case, when the microcomputer 104 detects the failure concerned, the microcomputer 104 itself stops the drive control of the synchronous motor 100. When the microcomputer 204 detects the failure concerned, the microcomputer 204 must notify the microcomputer 104 to stop the drive control of the synchronous motor 100.

When substituting for the entire motor drive processing with the microcomputer 204 in the case of failure of other than the CPU 110 in the microcomputer 104, the recovery is completely the same as that of the above. In particular, failure of the PWM 115 may be detected based on a waveform abnormality of the signals U, V, W, UB, VB, and WB with the use of the timer counter 112, or may be determined by whether the feedback control to the PWM 115 by the CPU 110 is deviated from an expectation value greatly.

<<4. Recovering Failure of the CPU 110 by the Entire of the Microcomputer 204>>

When failure has occurred in the CPU 110, the drive control of the synchronous motor to be performed by the microcomputer 104 must be recovered by the entire of the microcomputer 204, as is the case described above.

However, since it is impossible to expect that the microcomputer 104 performs detection of failure, it is necessary to perform the detection of failure by the microcomputer 204. For example, the CPU 210 performs periodical transmission to the CPU 110 through the communication path 300, and failure can be detected by whether there is normal response to the transmission.

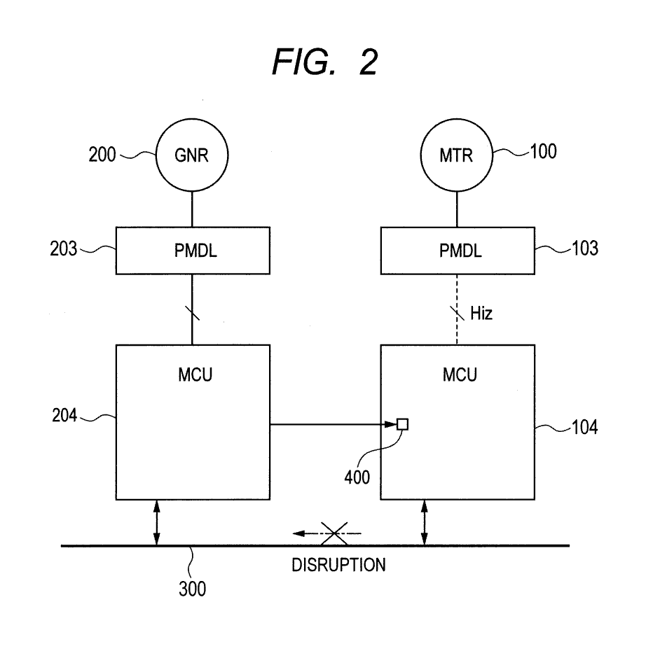

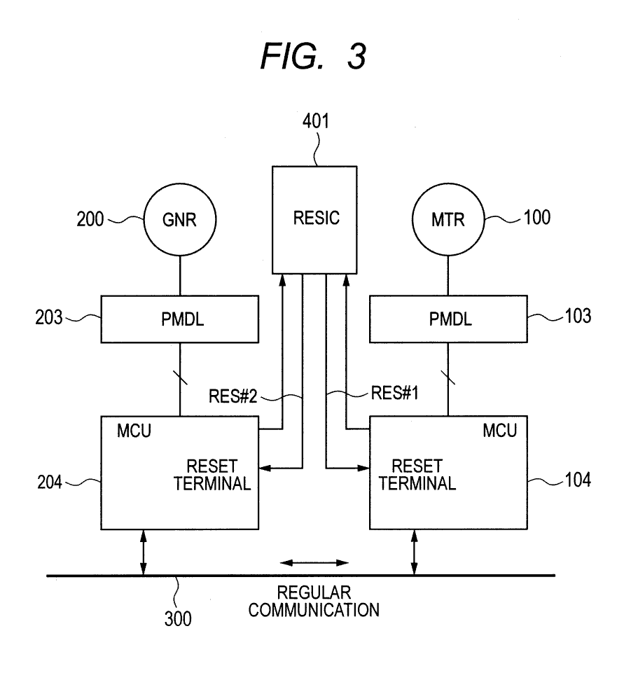

When failure occurs in the CPU 110, outputs of the conversion circuit 114 and the PWMs 115 and 116 become undefined, and cause malfunction. Therefore, it is necessary to forcibly set the output of the microcomputer 110 which has failure into a high output-impedance state. For example, as illustrated in FIG. 2, what is necessary is just to adopt a configuration in which a specific external terminal 400 for externally controlling the output of the microcomputer 110 to a high output-impedance state is provided, and the external terminal 400 is enabled by a signal 301, when the microcomputer 204 detects failure of the microcomputer 104. Alternatively, as illustrated in FIG. 3, what is necessary is just to adopt a reset circuit (RESIC) 401 which is provided with a function similar to a watchdog timer. The reset circuit has a function to initialize a timer count value, when a response from the microcomputer 104 is received before count-out of the timer count value, and to provide a reset instruction to the microcomputer 104 concerned by means of a reset signal RES#1, to preserve the state, when a response from the microcomputer 104 is not received before the count-out. The reset cancel may be issued to the reset circuit 401 by the microcomputer 204 on the opposite side. Similarly, also to the microcomputer 204, the reset circuit 401 is provided with a function to initialize a timer count value, when a response from the microcomputer 204 is received before the count-out of the timer count value, and to provide a reset instruction to the microcomputer 204 concerned by means of a reset signal RES#2, to preserve the state, when a response from the microcomputer 204 is not received before the count-out. The reset cancel may be issued to the reset circuit 401 by the microcomputer 104 on the opposite side. It is preferable to adopt the present measure by the reset circuit 401, when the microcomputer 104 does not have a function to control the output to a high impedance state in response to instructions from the microcomputer 204.

In addition to the above, the recovery processing when failure has occurred in the CPU 110 is performed as follows. That is, when the failure concerned is detected, as substitute for the conversion by the RDC of the conversion circuit 114 of the microcomputer 104, the ADC of the conversion circuit 214 of the second microcomputer 204 inputs the current signals IV and IW of the synchronous motor 100 from the path PAST, and converts them into digital data, and the CPU 210 estimates the rotational position and speed of the motor 100 based on the conversion result. Accordingly, the drive control of the synchronous motor 100 is performed through the path PAS2 using the PWM 216.

<<5. Recovering Conversion Failure of Current Signals IV and IW in the Power Generation Control, within a Failure Range>>

When there occurs failure that the ADC of the conversion circuit 214 can not perform conversion of the current signals IV and IW which are fed back from the synchronous generator 200, the conversion operation of the ADC in the conversion circuit 214 of the microcomputer 204 is substituted by the conversion operation of the ADC in the conversion circuit 114 of the microcomputer 104. That is, the conversion circuit 114 of the microcomputer 104 receives the current signals IV and IW from a path PAS3, the CPU 110 transmits digital data converted by the ADC to the microcomputer 204 from the external communication interface circuit 113, and the CPU 210 of the microcomputer 204 receives the digital data, and uses it for the power generation control of the synchronous generator. Since the microcomputer 104 should just take in the current signals IV and IW according to the operation program of the CPU 110 and just carry out arithmetic processing, realization of the control processing to be performed instead is easy.

When the microcomputer 204 itself performs failure detection of the ADC of the conversion circuit 214, failure is detected by inquiring into the state where a detection value deviates from a target value greatly in the feedback control performed by the CPU 210 using the current signals IV and IW, or, failure of the main ADC is detected by employing one of the plural ADCs as an auxiliary ADC with low sampling frequency. The microcomputer 204 must notify the microcomputer 104 of the detection result of the failure occurrence concerned. In this way, the unrecognizable failure to the current signals IV and IW of the fixed winding of the synchronous generator 200 can be easily detected, by utilizing a function which the microcomputer 204 has originally, like processing to make the CPU 210 determine whether the current signals IV and IW of the fixed winding of the synchronous generator 200 are as expected by the current command or the torque command as the drive command of the synchronous generator 200. The microcomputer 104 which receives the detection result can avoid the burden of detecting the failure concerned.

When the microcomputer 104 is used for failure detection of the ADC of the conversion circuit 214, one of the plural ADCs of the microcomputer 104 is employed as an auxiliary ADC with low sampling frequency, and the conversion result is periodically notified to the microcomputer 204. The present scheme is effective when there is no available ADC to be used as an auxiliary ADC in the microcomputer 204.

When there occurs failure that the ADC of the conversion circuit 214 can not perform the conversion of the current signals IV and IW which are fed back from the synchronous generator 200, if the conversion circuit 214 has plural ADCs, the recovery may be performed by switching to conversion by another ADC. Also in this case, the failure may be detected by the same way as described above.

<<6. Recovering Conversion Failure to a Resolver Digital Angle Data in the Power Generation Control, within a Failure Range>>

When it is detected that failure in conversion exists in the RDC of the conversion circuit 214 to the resolver output signal 202 from the rotation angle sensor 201 of the synchronous generator 200, as substitute for the conversion by the RDC of the conversion circuit 214 of the microcomputer 204, a free ADC in the conversion circuit 214 inputs the current signals IV and IW of the synchronous generator 200 and converts them into digital data, and the CPU 210 estimates a rotational position of the generator based on the digital data. Accordingly, the power generation control of the synchronous generator is performed. Even if it is not possible to perform a highly precise rotation angle control based on the resolver output signal 202 from the rotation angle sensor 201 of the synchronous generator 200, the drive control of the synchronous generator can be performed easily by a sensorless drive which is the existing control, by using the current signals IV and IW.

When there is no free ADC in the conversion circuit 214, the ADC of the conversion circuit 114 of the microcomputer 104 inputs the current signals IV and IW of the synchronous generator 200 from the path PAS3, and converts them into digital data, the microcomputer 204 receives the conversion result via the communication path 300, and the CPU 210 estimates the rotational position of the generator based on the digital data. Accordingly, the power generation control of the synchronous generator may be performed. At this time, it is not a best policy to convert the resolver output signal 202 of the synchronous generator 200 using the RDC of the conversion circuit 114 of the microcomputer 104. Namely, even if the microcomputer 104 tries to utilize the resolver output signal 202 directly, cable run lengths of a communication channel of the resolver output signal 202 become too long, so that the RDC which converts the resolver output signal 202 into a rotation angle will be influenced markedly by parasitic capacitance at the input, and it is likely that the conversion accuracy falls significantly. Therefore, there is no effectiveness.

Failure in conversion of the RDC of the conversion circuit 214 may be detected by analyzing the conversion result by the ADC of the conversion circuit 214 with the CPU 210, or by using simultaneously the disconnection detection function of the RDC in the conversion circuit 214, furthermore by inquiring into the state where a detection value deviates from a target value greatly in the feedback control performed by the CPU 210 using the output of the RDC, and others.

<<7. Recovering Failure of the Microcomputer 204 Other than the CPU 210, by the Entire of the Microcomputer 104>>

In any one of failure of the PWM 215 assigned to control of the PMDL 203, conversion failure of the current signals IV and IW, and conversion failure to the resolver digital angle data, the power generation control of the synchronous generator to be performed by the microcomputer 204 may be recovered by the entire of the microcomputer 104.

For example, when it is detected that failure in conversion exists in the RDC of the conversion circuit 214 to the resolver output signal 202 from the rotation angle sensor 201 of the synchronous generator 200, as substitute for the conversion by the RDC of the conversion circuit 214 of the microcomputer 204, the ADC of the conversion circuit 114 of the microcomputer 104 inputs the current signals IV and IW of the synchronous generator 200 from the path PAS3, and converts them into digital data, and the CPU 110 estimates the rotational position and speed of the generator 200 based on the conversion result. Accordingly, the drive control of the synchronous generator 200 is performed through the path PAS4 using the PWM 116. In this case, when the microcomputer 204 detects the failure concerned, the microcomputer 204 itself stops the drive control of the synchronous generator 200. When the microcomputer 104 detects the failure concerned, the microcomputer 104 must notify the microcomputer 204 to stop the drive control of the synchronous generator 200.

When substituting for the entire power generation control processing with the microcomputer 104 in the case of failure of other than the CPU 210 in the microcomputer 204, the recovery is completely the same as that of the above. In particular, failure of the PWM 215 may be detected based on a waveform abnormality of the signals U, V, W, UB, VB, and WB with the use of the timer counter 212, or may be determined by whether the feedback control to the PWM 215 by the CPU 210 is deviated from an expectation value greatly.

<<8. Recovering Failure of the CPU 210 by the Entire of The Microcomputer 104>>

When failure has occurred in the CPU 210, the power generation control of the synchronous generator to be performed by the microcomputer 204 must be recovered by the entire of the microcomputer 104, as is the case described above.

However, since it is impossible to expect that the microcomputer 204 performs detection of failure, it is necessary to perform the detection of failure by the microcomputer 104. For example, the CPU 110 performs periodical transmission to the CPU 210 through the communication path 300, and failure can be detected by whether there is normal response to the transmission.

When failure occurs in the CPU 210, outputs of the conversion circuit 214 and the PWMs 215 and 261 become undefined, and cause malfunction. Therefore, it is necessary to forcibly set the output of the microcomputer 210 which has failure into a high output-impedance state. For example, what is necessary is just to adopt a configuration in which a specific external terminal (not shown) for externally controlling the output of the microcomputer 210 to a high output-impedance state is provided, and the external terminal concerned is enabled, when the microcomputer 204 detects failure of the microcomputer 104. Alternatively, a reset signal RES#2 of the reset circuit (RESIC) 401 may be used.

In addition to the above, the recovery processing when failure has occurred in the CPU 210 is performed as follows. That is, when the failure concerned is detected, as substitute for the conversion by the RDC of the conversion circuit 214 of the microcomputer 204, the ADC of the conversion circuit 114 of the microcomputer 104 inputs the current signals IV and IW of the synchronous generator 200 from the path PAS3, and converts them into digital data, and the CPU 110 estimates the rotational position and speed of the generator 200 based on the conversion result. Accordingly, the drive control of the synchronous generator 200 is performed through the path PAS4 using the PWM 116.

<<Operating Sequences of the Drive Control and the Power Generation Control>>

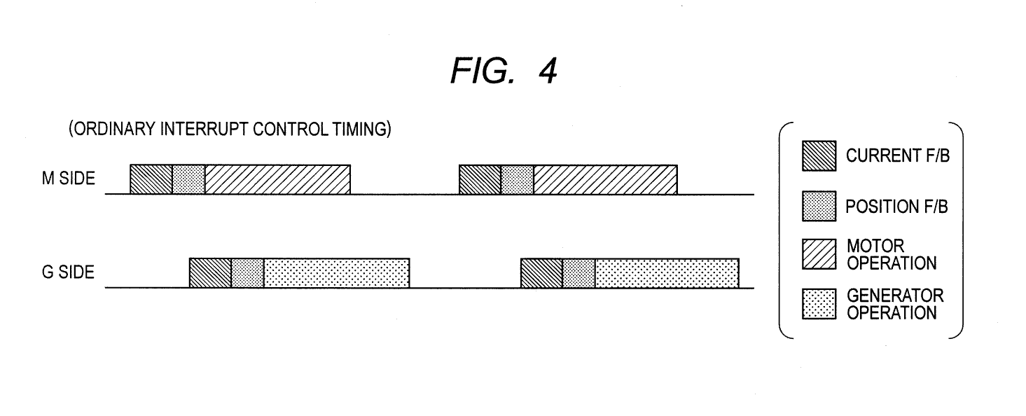

FIG. 4 illustrates operating sequences of the drive control of the synchronous motor 100 and the power generation control of the synchronous generator 200. “M side” illustrates a drive control sequence of the synchronous motor 100, and “G side” illustrates a power generation control sequence of the synchronous generator 200. “Current F/B” means the current signals IV and IW of the synchronous motor 100, and “Position F/B” means the resolver output signal 102 of the synchronous motor 100. “Motor Operation” means the drive control operation by the microcomputer 104 for the synchronous motor 100, and “Generator Operation” means the power generation control operation by the microcomputer 204 for the synchronous generator 200.

Although not limited in particular, it is assumed that the drive control of the synchronous motor 100 is repeated by the microcomputer 104 using timer interrupt, in response to an acceleration command. Similarly, it is assumed that the power generation control of the synchronous generator 200 is repeated by the microcomputer 204 using a timer interrupt, in response to a power generation command. As illustrated in FIG. 4, corresponding to an operation condition of a vehicle, the drive control of the synchronous motor 100 and the power generation control of the synchronous generator 200 are independently performed according to the timer interrupt.

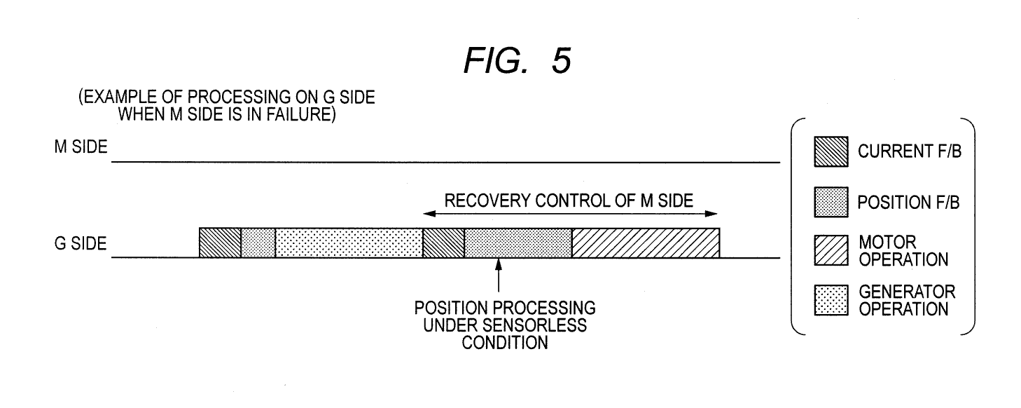

FIG. 5 illustrates a control sequence in which, when the microcomputer 104 for performing the drive control of the synchronous motor 100 has failure, all the motor control functions to be performed by the microcomputer 104 are performed by the microcomputer 204 instead. As illustrated in FIG. 5, for example, the microcomputer 204 performs the drive control of the synchronous motor 100 in a halt period of the power generation control. Since the microcomputer 204 performs the drive control of the synchronous motor 100 by the sensorless drive which uses the A/D conversion data of the current signals IV and IW, as described above, the processing time becomes longer compared with the case where the resolver digital conversion signal is used. Also in this point of view, the rotational performance of the motor is poorer compared with the rotational performance under the normal control by the microcomputer 104. However, it is sufficient that driving the motor as emergency action is possible, and, there is no problem substantially.

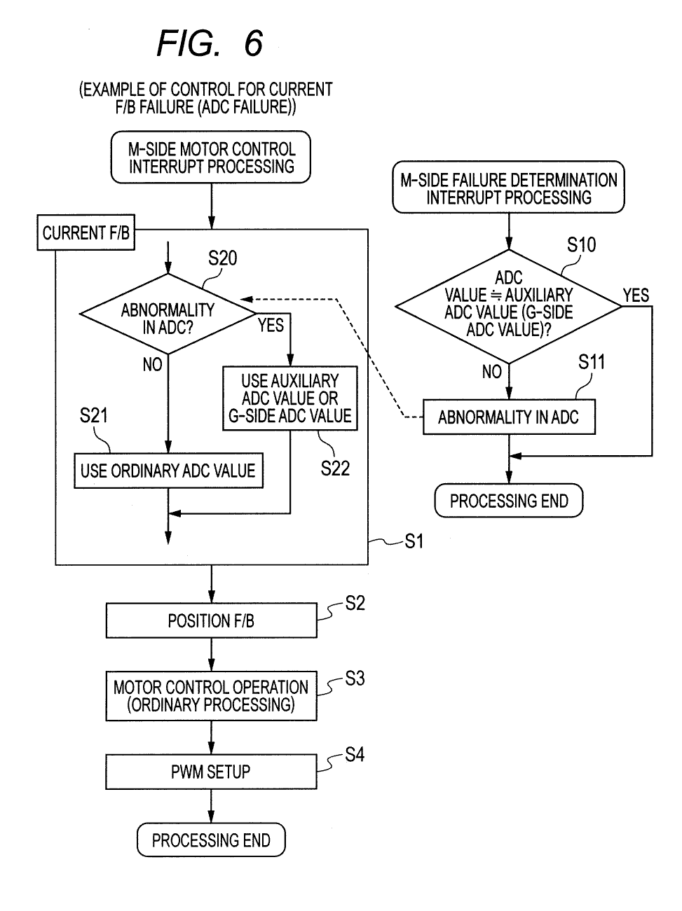

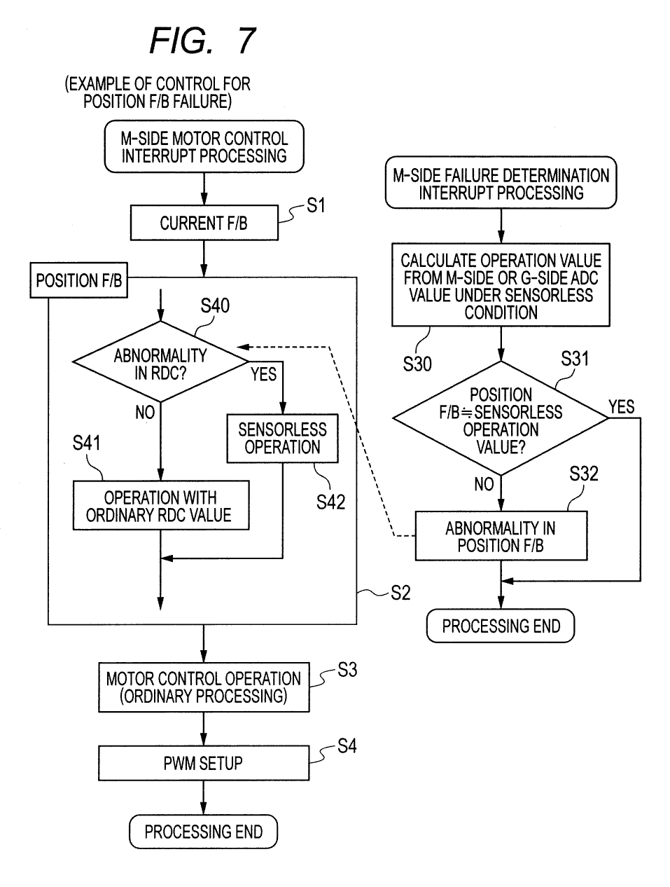

FIG. 6 and FIG. 7 illustrate a flow of control of the microcomputer 104 when failure of the microcomputer 104 for performing drive control of the synchronous motor 100 is recovered using a marginal resource of the microcomputer. FIG. 6 assumes that the ADC of the conversion circuit 114 responds to a conversion failure of the current signals IV and IW. FIG. 7 assumes that the RDC of the conversion circuit 114 responds to a resolver digital conversion failure of the resolver signals 102.

A basic control flow illustrated in FIG. 6 and FIG. 7 is processing responding to one timer interrupt of the motor drive control. The drive control of the microcomputer 104 includes A/D conversion of the current F/B by the ADC (S1), resolver digital conversion of the position F/B by the RDC (S2), CPU operation for the motor control using the result of Step S1 and Step S2 (S3), and a setup of the PWM 115 based on the CPU operation result (S4).

In the case of FIG. 6, performing the M-side failure determination interrupt processing, the microcomputer 104 determines whether the A/D conversion result to the current signals IV and IW of the synchronous motor 100 is almost equal to (not deviated greatly from) the A/D conversion result by an auxiliary ADC (or the conversion result using the ADC of the microcomputer 204 on the G side) (S10). When they are almost equal, the microcomputer 104 determines that the ADC concerned is normal, otherwise the microcomputer 104 determines that the ADC concerned is in failure and sets an ADC failure flag as the determination result of “ADC failure” (S11).

In the A/D conversion processing (S1) of the M-side motor control interrupt processing, existence or nonexistence of an ADC abnormality is determined with reference to the ADC failure flag (S20). If no abnormalities are found, the A/D conversion value then measured is used (S21). If abnormalities are found, the conversion result obtained by the auxiliary ADC or the conversion result obtained by using the ADC of the microcomputer 204 on the G side is used (S22). In FIG. 6, the contents of processing by the M-side failure determination interrupt processing may be performed in the A/D conversion processing (S1). It is also preferable that the microcomputer 204 may perform the entire recovery processing, according to the determination result of the ADC abnormality by the M-side failure determination interrupt processing.

In the case of FIG. 7, performing the M-side failure determination interrupt processing, the microcomputer 104 calculates a position operation value for the sensorless drive (an operation value under sensorless condition), using the A/D conversion result to the resolver output signal 102 on the side of synchronous motor 100 (or the conversion result using the ADC of the microcomputer 204 on the G side) (S30). The microcomputer 104 determines whether the calculated sensorless operation value is almost equal to (not deviated greatly from) the conversion result (the position F/B value) by the resolver digital converter (RDC) (S31). When they are almost equal, the microcomputer 104 determines that the RDC concerned is normal, otherwise the microcomputer 104 determines that the RDC concerned is in failure (position F/B abnormality), and sets an RDC failure flag as the determination result of “position F/B abnormality” (S32).

In the resolver digital conversion processing (S2) of the M-side motor control interrupt processing, existence or nonexistence of an RDC abnormality is determined with reference to the RDC failure flag (S40). If no abnormalities are found, the RDC conversion value then measured is used (S41). If abnormalities are found, the operation result for the sensorless drive is used (S42). In FIG. 7, the contents of processing by the M-side failure determination interrupt processing may be performed in the resolver digital conversion processing (S2). It is also preferable that the microcomputer 204 may perform the entire recovery processing, according to the determination result of the RDC abnormality by the M-side failure determination interrupt processing.

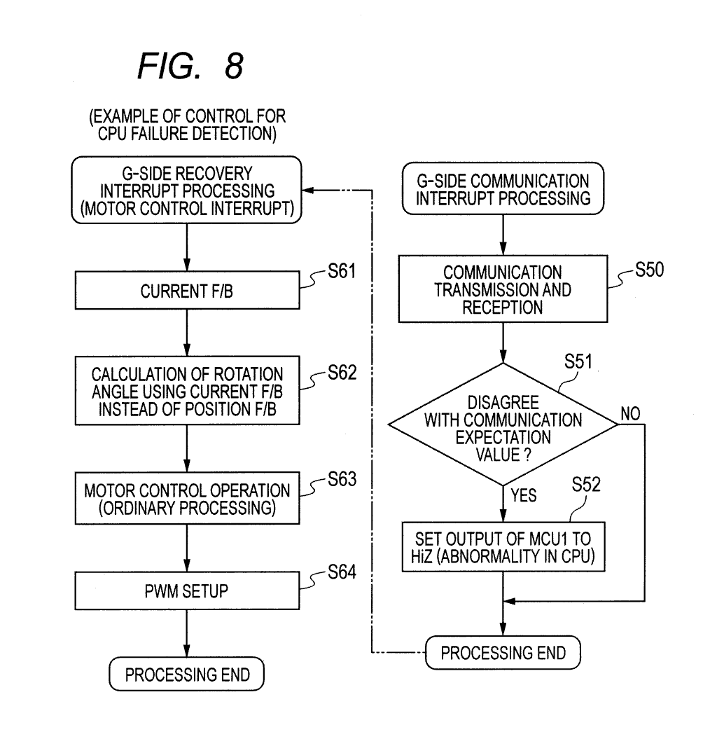

FIG. 8 illustrates a flow of control of the microcomputer 204 when the microcomputer 104 for performing drive control of the synchronous motor 100 has a CPU failure, and all of the motor drive controls to be performed by the microcomputer 104 are performed by the microcomputer 204 instead.

In the G-side communication interrupt processing illustrated in FIG. 8, the microcomputer 204 communicates with the microcomputer 104 via the communication path 300 (S50), and it is determined whether there is a response as expected (S51). When there is a response as expected, it is determined that the microcomputer 104 is normal, otherwise it is determined that the microcomputer 104 is in failure, and the output of the microcomputer 104 is controlled to a high impedance state by the signal 301 of FIG. 2 (S52).

When an abnormal termination occurs, responding to the acceleration command, the system shifts to the G-side recovery interrupt processing, and the microcomputer 204 performs the drive control of the motor 100. The control includes the A/D conversion of the current F/B on the side of the motor 100 by the ADC of the conversion circuit 214 (S61), the calculation of a rotation angle for the sensorless drives by the current F/B on the side of the motor 100 (S62), the CPU operation for the motor control using the result of Step S61 and Step S62 (S63), and the setup of the PWM 115 based on the CPU operation result (S64).

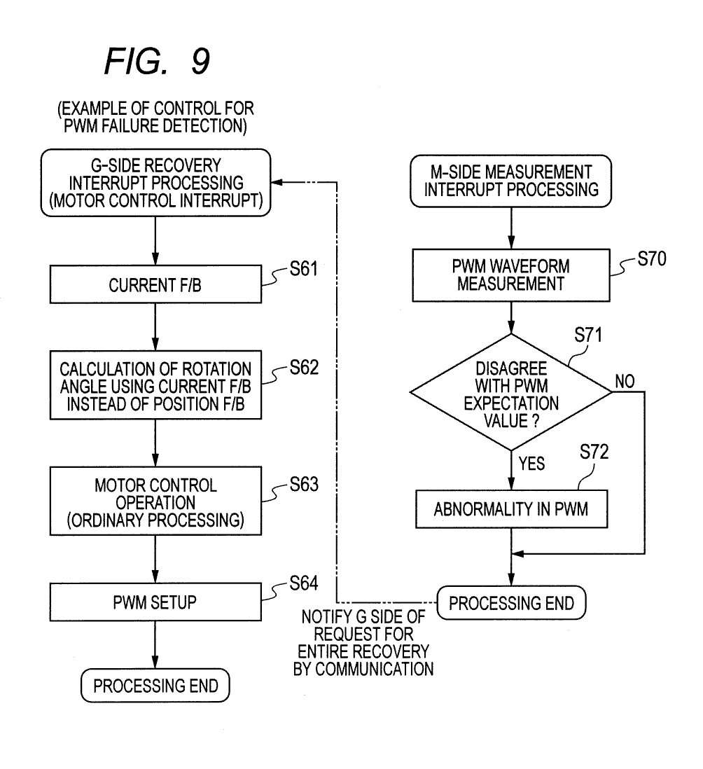

FIG. 9 illustrates a flow of control of the microcomputer 204 when the microcomputer 104 for performing the drive control of the synchronous motor 100 has a PWM failure, and the motor drive control to be performed by the microcomputer 104 is performed by the microcomputer 204 instead.

In the M-side measurement interrupt processing illustrated in FIG. 9, the CPU 110 of the microcomputer 104 measures waveform of an output switching control signal of the PWM 115 (S70), and determines whether the measured waveform is an expected waveform (S71). When the measured waveform is the expected waveform, the processing terminates normally. Otherwise, the CPU 110 controls the output of the PWM 115 to a high impedance state, and notifies the microcomputer 204 of the PWM failure via the communication path 300 (S72). Upon receiving the notice, the microcomputer 204 shifts to the G-side recovery interrupt processing in response to the acceleration command, and the microcomputer 204 performs the drive control of the motor 100. The control is the same as illustrated in FIG. 8.

Although not shown especially, when the power generation control function of the synchronous generator is in failure and the failure is recovered by using the drive control mechanism of the synchronous motor, the processing is the same as described above.

### Embodiment 2

### A Single Microcomputer System

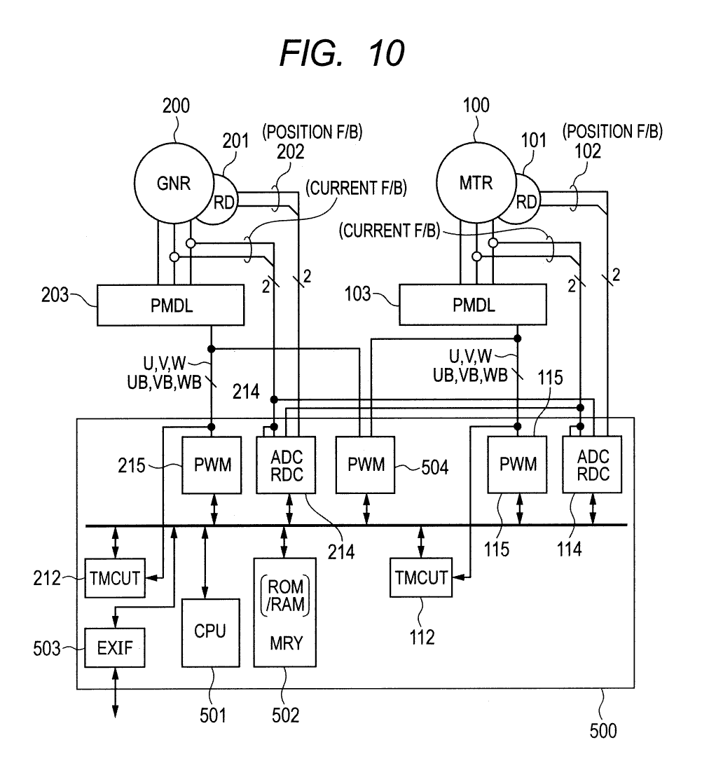

FIG. 10 illustrates an embodiment for the case of controlling a synchronous motor and a synchronous generator by one microcomputer. FIG. 10 is different from FIG. 1 in the point that the microcomputers 104 and 204 illustrated in FIG. 1 are integrated into a single chip as one microcomputer 500. The microcomputer 500 comprises a CPU 501, a MRY 502, an EXIF 503, and a PWM 504 which are respectively consolidated from the counterparts of the two microcomputers 104 and 204. The microcomputer 500 comprises other circuit modules which are the same as illustrated in the two microcomputers 104 and 204. The memory 502 stores a program to be used for control of the synchronous motor 100 and control of the synchronous generator 200. The CPU 501 performs control of the synchronous motor 100 and control of the synchronous generator 200. The system configuration illustrated in FIG. 10 produces the fundamentally same working-effect as the system configuration illustrated in FIG. 1. As the difference, it is impossible that the microcomputer 104 which has failure is substituted for with the microcomputer 204, as described above. The recovery processing is restricted to using a marginal resource provided inside the microcomputer 500. Except for the present difference, as far as the CPU 501 does not have failure, the failure of drive control function to the synchronous motor 100 in the microcomputer 500 can be recovered in the same way as described above.

When a single-chip microcomputer configured by multiple CPUs is used, and when the first CPU assigned to the drive control of the synchronous motor 100 has failure, it is possible that the drive control function of the first CPU is performed instead by the second CPU assigned to the power generation control of the synchronous generator. Such a configuration is substantially identical to that of Embodiment 1, except that the configuration is realized over one semiconductor substrate.

As clarified by the above explanation, in a system provided with the motor control function and the generator control function, it is possible that failure of one side is recovered by the control function of the other side. In the control after the recovery, priority is given to the motor drive control rather than the generator control, when top priority is given to a run. When there occurs battery deficiency that the run itself becomes impracticable if priority is not given to the power generation of the generator, it is also possible to give high priority to the power generation of the generator and to give low priority to the recovery operation of the motor drive for a run. Since it is an emergency action at the time of failure, priority is not given to either raising a rotational frequency or driving smoothly.

In control when one of the motor control function and the generator control function has failure and the other performs recovery of the failure, which of the motor drive control and the generator drive control shall be given priority is determined by considering distance to a place where a maintenance service can be received and geographical feature information, with reference to information obtained from a car-navigation system etc., and the electric energy currently stored in a battery. For example, priority is given to the motor drive control while running an uphill, and priority is given to the generator drive control on a downward slope. Even the function of the microcomputer which is not employed for the motor control usually can be diverted to the motor drive control by time sharing control or by loosing a control period, In this case, other controls will have lower efficiencies but can be supported by reducing the driving speed etc. In a hybrid vehicle, although an effect as in an electric vehicle can not be expected, the present invention is effective as far as efficiency is concerned. In a recovery operation of a hybrid vehicle, an engine may be treated as the subject.

As described above, the invention accomplished by the present inventors has been concretely explained based on various embodiments. However, it cannot be overemphasized that the present invention is not restricted to the embodiments, and it can be changed variously in the range which does not deviate from the gist.

For example, the application of the present invention is not limited to an electric vehicle or a hybrid vehicle, but the present invention can be applied to a hybrid railcar etc. which mounts a diesel engine and an electric motor. The peripheral circuits which the microcomputer has internally are not limited to the ones explained above, but can be changed suitably. The first controller for performing the motor control, and the second controller for performing the generator control are not limited to a single-chip microcomputer or a multichip microcomputer. The switch control of the switching circuit which performs the inverter operation and the rectifying operation is not limited to control performed by using the CPU and the PWM, but may be performed by using an exclusive drive circuit.

What is claimed is:

1. A power drive control device comprising:
a first controller operable to input a current signal of a fixed winding of a synchronous motor and a sense output from a rotation angle sensor of the synchronous motor, and operable to perform drive control for rotating the synchronous motor and regenerative control for controlling power generation by the synchronous motor; and
a second controller operable to input a current signal of a fixed winding of a synchronous generator and a sense output from a rotation angle sensor of the synchronous generator, and operable to perform power generation control for controlling power generation by the synchronous generator,
wherein, when it is detected that the first controller has unusable failure in the drive control of the synchronous motor, the second controller performs instead all or a part of the drive control to be performed by the first controller.

2. The power drive control device according to claim 1,
wherein, when unusable failure is detected in all or a part of the drive control of the synchronous motor performed by the first controller, the second controller performs instead all of the drive control of the synchronous motor to be performed by the first controller, by inputting a current signal of the fixed winding of the synchronous motor or a sense output from the rotation angle sensor of the synchronous motor, and performing the drive control for rotating the synchronous motor.

3. The power drive control device according to claim 1,
wherein, when unusable failure is detected in a part of the drive control of the synchronous motor performed by the first controller, the second controller performs instead the control related to the unusable failure in the first controller.

4. The power drive control device according to claim 1,
wherein the first controller and the second controller are respectively a first microcomputer and a second microcomputer, each provided with a different CPU.

5. The power drive control device according to claim 4,
wherein, when it is detected that the first microcomputer has unrecognizable failure to a current signal of the fixed winding of the synchronous motor, the second microcomputer performs instead processing to recognize the current signal of the fixed winding of the synchronous motor among the drive control of the synchronous motor to be performed by the first microcomputer.

6. The power drive control device according to claim 5,
wherein the first microcomputer detects the unrecognizable failure to the current signal of the fixed winding of the synchronous motor, and notifies the detection result of the failure concerned to the second microcomputer.

7. The power drive control device according to claim 5,
wherein the second microcomputer recognizes the current signal of the fixed winding of the synchronous motor, and returns the recognition result to the first microcomputer successively.

8. The power drive control device according to claim 4,
wherein, when it is detected that the first microcomputer has unrecognizable failure to a sense output from the rotation angle sensor of the synchronous motor, in place of the first microcomputer performing the drive control of the synchronous motor, the second microcomputer performs the drive control of the synchronous motor by recognizing a current signal of the fixed winding of the synchronous motor and estimating a rotational position and speed of the synchronous motor.

9. The power drive control device according to claim 8,
wherein the first microcomputer detects the unrecognizable failure to the sense output from the rotation angle sensor of the synchronous motor, and notifies the detection result of the failure concerned to the second microcomputer.

10. The power drive control device according to claim 4,
wherein, when it is detected that the first microcomputer has failure of a CPU, in place of the first microcomputer performing the drive control of the synchronous motor, the second microcomputer performs the drive control of the synchronous motor by recognizing a current signal of the fixed winding of the synchronous motor and estimating a rotational position and speed of the synchronous motor.

11. The power drive control device according to claim 10,
wherein, when the CPU of the second microcomputer detects a state of communication failure by performing a periodical communication with the CPU of the first microcomputer, the second microcomputer provides instructions to set an output of the first microcomputer to a high impedance state.

12. The power drive control device according to claim 10, further comprising:
a reset circuit operable to initialize a timer count value, when a response from the first microcomputer is received before count-out of the timer count value, and operable to provide a reset instruction to the first microcomputer concerned to hold the state, when a response from the first microcomputer is not received before the count-out.

13. The power drive control device according to claim 2,
wherein the first microcomputer comprises:
a first A/D conversion circuit operable to input a current signal of the fixed winding of the synchronous motor and to convert the inputted current signal into a digital signal;
a first angle conversion circuit operable to input a sense output from the rotation angle sensor of the synchronous motor and to convert the inputted sense output into angle data;
a first pulse generating circuit operable to generate an inverter switch control signal for a inverter switch operation in response to a drive command of the synchronous motor, and operable to generate a rectifier switch control signal for a rectifier switch operation in response to a regeneration command of the synchronous motor, the inverter switch control signal and the rectifier switch control signal being generated for a first switching circuit which performs the inverter switch operation to generate a driving current to the fixed winding of the synchronous motor, and the rectifier switch operation to rectify a regenerative current from the fixed winding of the synchronous motor; and
a first CPU operable to perform the drive control of the synchronous motor, by inputting outputs from the first A/D conversion circuit and the first angle conversion circuit, and by outputting the inverter switch control signal from the first pulse generating circuit to the first switching circuit in response to the drive command, and operable to perform the regenerative control of the synchronous motor, by outputting the rectifier switch control signal from the first pulse generating circuit to the first switching circuit in response to the regeneration command,
wherein the second microcomputer comprises:
a second A/D conversion circuit operable to input a current signal of the synchronous generator and to convert the inputted current signal into a digital signal;
a second angle conversion circuit operable to input a sense output from the rotation angle sensor of the synchronous generator and to convert the inputted sense output into angle data;
a second pulse generating circuit operable to generate a rectifier switch control signal for the rectifier switch operation in response to a power generation command of the synchronous generator, the rectifier switch control signal being generated for a second switching circuit which performs a rectifier switch operation to rectify current from the fixed winding of the synchronous generator; and
a second CPU operable to perform the power generation control of the synchronous generator, by inputting outputs from the second A/D conversion circuit and the second angle conversion circuit, and by outputting the rectifier switch control signal from the second pulse generating circuit to the second switching circuit, in response to the power generation command, and
wherein, when failure of the first A/D conversion circuit, the first pulse generating circuit, or the first CPU is detected, in response to the drive command, the second A/D conversion circuit inputs a current signal of the fixed winding of the synchronous motor and converts the inputted current signal into a digital signal, the second CPU estimates a rotational position and speed of the synchronous motor based on the digital signal converted by the second A/D conversion circuit, and the drive control of the synchronous motor is performed, with the second pulse generating circuit letting the switching circuit perform the inverter switch operation.

14. The power drive control device according to claim 4,
wherein the first controller and the second controller are one microcomputer which shares a CPU and comprises a first peripheral circuit for the first controller and a second peripheral circuit for the second controller.

15. The power drive control device according to claim 14,
wherein, when it is detected that the first peripheral circuit has unrecognizable failure to the feedback signal, the CPU performs recognition of a current signal of the fixed winding of the synchronous motor by using the second peripheral circuit instead, among the drive control of the synchronous motor to be performed by using the first peripheral circuit.

16. The power drive control device according to claim 14,
wherein, when it is detected that the first peripheral circuit has unrecognizable failure to a sense output from the rotation angle sensor of the synchronous motor, the CPU performs the drive control of the synchronous motor, by recognizing a current signal of the fixed winding of the synchronous motor using the second peripheral circuit, and estimating the rotational position and speed of the synchronous motor, instead of the drive control of the synchronous motor to be performed by using the first peripheral circuit.

17. The power drive control device according to claim 14,
wherein the first peripheral circuit comprises:
a first A/D conversion circuit operable to input a current signal of the fixed winding of the synchronous motor and to convert the inputted current signal into a digital signal;
a first angle conversion circuit operable to input a sense output from the rotation angle sensor of the synchronous motor and to convert the inputted sense output into angle data; and
a first pulse generating circuit operable to generate an inverter switch control signal for the inverter switch operation in response to a drive command of the synchronous motor, and operable to generate a rectifier switch control signal for the rectifier switch operation in response to a regeneration command of the synchronous motor, the inverter switch control signal and the rectifier switch control signal being generated for a first switching circuit which performs the inverter switch operation to generate a driving current to the fixed winding of the synchronous motor, and the rectifier switch operation to rectify a regenerative current from the fixed winding of the synchronous motor,
wherein the second peripheral circuit comprises:
a second A/D conversion circuit operable to input a current signal from the synchronous generator and to convert the inputted current signal into a digital signal;
a second angle conversion circuit operable to input a sense output from the rotation angle sensor of the synchronous generator and to convert the inputted sense output into angle data;
a second pulse generating circuit operable to generate a rectifier switch control signal for the rectifier switch operation in response to a power generation command of the synchronous generator, the rectifier switch control signal being generated for a second switching circuit which performs a rectifier switch operation to rectify current from the fixed winding of the synchronous generator;
wherein the CPU performs the drive control of the synchronous motor by inputting an output from the first A/D conversion circuit and the first angle conversion circuit, and outputting the inverter switch control signal from the first pulse generating circuit to the first switching circuit in response to the drive command, performs the regenerative control of the synchronous motor by outputting the rectifier switch control signal from the first pulse generating circuit to the first switching circuit in response to the regeneration command, and performs the power generation control of the synchronous generator by inputting outputs from the second A/D conversion circuit and the second angle conversion circuit, and by outputting the rectifier switch control signal from the second pulse generating circuit to the second switching circuit in response to the power generation command, and
wherein, when failure is detected in the first A/D conversion circuit or the first pulse generating circuit, the second A/D conversion circuit inputs a current signal of the fixed winding of the synchronous motor and converts the inputted current signal into a digital signal, in response to the drive command, and the CPU performs the drive control of the synchronous motor with the second pulse generating circuit letting the switching circuit perform the inverter switch operation, by estimating a rotational position and speed of the synchronous motor based on the digital signal converted by the second A/D conversion circuit.

18. A power drive control device comprising:
a first controller operable to input a current signal of a fixed winding of a synchronous motor and a sense output from a rotation angle sensor of the synchronous motor, and operable to perform drive control for rotating the synchronous motor and regenerative control for controlling power generation by the synchronous motor; and
a second controller operable to input a current signal of a fixed winding of a synchronous generator and a sense output from a rotation angle sensor of the synchronous generator, and operable to perform power generation control for controlling power generation by the synchronous generator,
wherein the first controller and the second controller are respectively a first microcomputer and a second microcomputer, each provided with a different CPU,
wherein the first microcomputer comprises multiplexed A/D conversion circuits which convert a current signal of the fixed winding of the synchronous motor into a digital signal,
wherein, when a main A/D conversion circuit is in failure, an auxiliary A/D conversion circuit is switched so as to act as a substitute and converts a current signal of the fixed winding of the synchronous motor into a digital signal,
wherein the first microcomputer comprises an angle conversion circuit which inputs a sense output from the rotation angle sensor of the synchronous motor and converts the sense output into angle data, and
wherein, when the angle conversion circuit is in failure, the first microcomputer performs the drive control of the synchronous motor, by estimating a rotational position and speed of the synchronous motor based on the digital signal into which the A/D conversion circuit has converted the current signal of the fixed winding of the synchronous motor.

19. A power device comprising:
a synchronous motor;
a first switching circuit operable to perform an inverter switch operation to generate a driving current to a fixed winding of the synchronous motor, and a rectifier switch operation to rectify a regenerative current from the fixed winding of the synchronous motor;
a rotation angle sensor of the synchronous motor;
a first controller operable to input a current signal of the fixed winding of the synchronous motor and a sense output from the rotation angle sensor of the synchronous motor, operable to output an inverter switch control signal for the inverter switch operation to the first switching circuit in response to a drive command of the synchronous motor, and operable to output a rectifier switch control signal for the rectifier switch operation to the first switching circuit in response to a regeneration command of the synchronous motor;
a synchronous generator;
a second switching circuit operable to perform a rectifier switch operation to rectify current from a fixed winding of the synchronous generator;
a rotation angle sensor of the synchronous generator; and
a second controller operable to input a sense signal of the rotation angle sensor of the synchronous generator and a current signal from the fixed winding of the synchronous generator, and operable to output a rectifier switch control signal for the rectifier switch operation to the second switching circuit in response to a power generation command of the synchronous generator,
wherein, when it is detected that the first controller has unusable failure in the drive control of the synchronous motor, the second controller performs instead all or a part of the drive control to be performed by the first controller.

20. The power device according to claim 19,
wherein the first controller and the second controller are respectively a first microcomputer and a second microcomputer, each provided with a different CPU.

21. The power device according to claim 20,
wherein, when it is detected that the first microcomputer has unrecognizable failure to a current signal of the fixed winding of the synchronous motor, the second microcomputer performs instead processing to recognize the current signal of the fixed winding of the synchronous motor among the drive control of the synchronous motor to be performed by the first microcomputer.

22. The power device according to claim 20,
wherein, when it is detected that the first microcomputer has unrecognizable failure to a sense output from the rotation angle sensor of the synchronous motor, in place of the first microcomputer performing the drive control of the synchronous motor, the second microcomputer performs the drive control of the synchronous motor by recognizing a current signal of the fixed winding of the synchronous motor and estimating a rotational position and speed of the synchronous motor.

23. The power device according to claim 20,
wherein, when it is detected that the first microcomputer has failure of a CPU, in place of the first microcomputer performing the drive control of the synchronous motor, the second microcomputer performs the drive control of the synchronous motor by recognizing a current signal of the fixed winding of the synchronous motor and estimating a rotational position and speed of the synchronous motor.

24. The power device according to claim 19,
wherein the first controller and the second controller are one microcomputer which shares a CPU and comprises a first peripheral circuit for the first controller and a second peripheral circuit for the second controller.

25. A power device comprising:
a synchronous motor;
a first switching circuit operable to perform an inverter switch operation to generate a driving current to a fixed winding of the synchronous motor, and a rectifier switch operation to rectify a regenerative current from the fixed winding of the synchronous motor;
a rotation angle sensor of the synchronous motor;
a first controller operable to input a current signal of the fixed winding of the synchronous motor and a sense output from the rotation angle sensor of the synchronous motor, operable to output an inverter switch control signal for the inverter switch operation to the first switching circuit in response to a drive command, and operable to output a rectifier switch control signal for the rectifier switch operation to the first switching circuit in response to a regeneration command;
a synchronous generator;
a second switching circuit operable to perform a rectifier switch operation to rectify current from a fixed winding of the synchronous generator;
a rotation angle sensor of the synchronous generator; and
a second controller operable to input a sense signal of the rotation angle sensor of the synchronous generator and a current signal from the fixed winding of the synchronous generator, and operable to output a rectifier switch control signal for the rectifier switch operation to the second switching circuit in response to a power generation command,
wherein the first controller and the second controller are respectively a first microcomputer and a second microcomputer, each provided with a different CPU,
wherein the first microcomputer comprises multiplexed A/D conversion circuits which convert a current signal of the fixed winding of the synchronous motor into a digital signal,
wherein, when a main A/D conversion circuit is in failure, an auxiliary A/D conversion circuit is switched so as to act as a substitute and converts a current signal of the fixed winding of the synchronous motor into a digital signal,
wherein the first microcomputer comprises an angle conversion circuit which inputs a sense output from the rotation angle sensor of the synchronous motor and converts the sense output into angle data, and
wherein, when the angle conversion circuit is in failure, the first microcomputer performs drive control of the synchronous motor, by estimating a rotational position and speed of the synchronous motor based on the digital signal into which the A/D conversion circuit has converted the current signal of the fixed winding of the synchronous motor.

26. A power drive control device comprising:
a first controller operable to input a current signal of a fixed winding of a synchronous motor and a sense output from a rotation angle sensor of the synchronous motor, and operable to perform drive control for rotating the synchronous motor and regenerative control for controlling power generation by the synchronous motor; and
a second controller operable to input a current signal of a fixed winding of a synchronous generator and a sense output from a rotation angle sensor of the synchronous generator, and operable to perform power generation control for controlling power generation by the synchronous generator,
wherein, when it is detected that the second controller has unusable failure in the power generation control of the synchronous generator, the first controller performs instead all or a part of the power generation control of the synchronous generator to be performed by the second controller.

27. A power drive control device comprising:
a first controller operable to input a current signal of a fixed winding of a synchronous motor and a sense output from a rotation angle sensor of the synchronous motor, and operable to perform drive control for rotating the synchronous motor and regenerative control for controlling power generation by the synchronous motor; and
a second controller operable to input a current signal of a fixed winding of a synchronous generator and a sense output from a rotation angle sensor of the synchronous generator, and operable to perform power generation control for controlling power generation by the synchronous generator,
wherein the first controller and the second controller are respectively a first microcomputer and a second microcomputer, each provided with a different CPU,
wherein the second microcomputer comprises multiplexed A/D conversion circuits which convert the current signal into a digital signal,
wherein, when a main A/D conversion circuit is in failure, an auxiliary A/D conversion circuit is switched so as to act as a substitute and converts the current signal into a digital signal,
wherein the second microcomputer comprises an angle conversion circuit which inputs a sense output from the rotation angle sensor of the synchronous generator and converts the sense output into angle data, and
wherein, when the angle conversion circuit is in failure, the second microcomputer performs the power generation control of the synchronous generator, by estimating a rotational position and speed of the synchronous generator based on the digital signal into which the A/D conversion circuit has converted the current signal.

28. A power device comprising:
a synchronous motor;
a first switching circuit operable to perform an inverter switch operation to generate a driving current to a fixed winding of the synchronous motor, and a rectifier switch operation to rectify a regenerative current from the fixed winding of the synchronous motor;
a rotation angle sensor of the synchronous motor;
a first controller operable to input a current signal of the fixed winding of the synchronous motor and a sense output from the rotation angle sensor of the synchronous motor, operable to output an inverter switch control signal for the inverter switch operation to the first switching circuit in response to a drive command, and operable to output a rectifier switch control signal for the rectifier switch operation to the first switching circuit in response to a regeneration command;
a synchronous generator;
a second switching circuit operable to perform a rectifier switch operation to rectify current from a fixed winding of the synchronous generator;
a rotation angle sensor of the synchronous generator; and
a second controller operable to input a sense signal of the rotation angle sensor of the synchronous generator and a current signal from the fixed winding of the synchronous generator, and operable to output a rectifier switch control signal for the rectifier switch operation to the second switching circuit in response to a power generation command,
wherein, when it is detected that the second controller has unusable failure in the power generation control of the synchronous generator, the first controller performs instead all or a part of the power generation control to be performed by the second controller.

29. A power device comprising:
a synchronous motor;
a first switching circuit operable to perform an inverter switch operation to generate a driving current to a fixed winding of the synchronous motor, and a rectifier switch operation to rectify a regenerative current from the fixed winding of the synchronous motor;
a rotation angle sensor of the synchronous motor;
a first controller operable to input a current signal of the fixed winding of the synchronous motor and a sense output from the rotation angle sensor of the synchronous motor, operable to output an inverter switch control signal for the inverter switch operation to the first switching circuit in response to a drive command, and operable to output a rectifier switch control signal for the rectifier switch operation to the first switching circuit in response to a regeneration command;
a synchronous generator;
a second switching circuit operable to perform a rectifier switch operation to rectify current from a fixed winding of the synchronous generator;
a rotation angle sensor of the synchronous generator; and
a second controller operable to input a sense signal of the rotation angle sensor of the synchronous generator and a current signal from the fixed winding of the synchronous generator, and operable to output a rectifier switch control signal for the rectifier switch operation to the second switching circuit in response to a power generation command,
wherein the first controller and the second controller are respectively a first microcomputer and a second microcomputer, each provided with a different CPU,
wherein the second microcomputer comprises multiplexed A/D conversion circuits which convert a current signal of a fixed winding of the synchronous generator into a digital signal,
wherein, when a main A/D conversion circuit is in failure, an auxiliary A/D conversion circuit is switched so as to act as a substitute and converts a current signal of the fixed winding of the synchronous generator into a digital signal,
wherein the second microcomputer comprises an angle conversion circuit which inputs a sense output from the rotation angle sensor of the synchronous generator and converts the sense output into angle data, and
wherein, when the angle conversion circuit is in failure, the second microcomputer performs the power generation control of the synchronous generator, by estimating a rotational position and speed of the synchronous generator based on the digital signal into which the A/D conversion circuit has converted the current signal of the fixed winding of the synchronous generator.
